(19) United States
(12) Patent Application Publication
(10) Pub. No.: US 2026/0095679 A1
(43) Pub. Date: Apr. 2, 2026

(54) IMAGE SENSOR AND ELECTRONIC DEVICE INCLUDING THE SAME

(71) Applicant: SAMSUNG ELECTRONICS CO., LTD., Suwon-si (KR)

(72) Inventors: Soongeun JANG, Suwon-si (KR); Sookyoung ROH, Suwon-si (KR); Junho LEE, Suwon-si (KR)

(73) Assignee: SAMSUNG ELECTRONICS CO., LTD., Suwon-si (KR)

(21) Appl. No.: 19/180,717

(22) Filed: Apr. 16, 2025

(30) Foreign Application Priority Data
Sep. 30, 2024 (KR) 10-2024-0133254

(51) Int. Cl. H04N 25/17; H04N 23/55; H04N 25/13

(52) U.S. Cl. CPC H04N 25/17; H04N 23/55; H04N 25/134

(57) ABSTRACT

Provided is an image sensor including a sensor board including a plurality of unit pixel groups including a plurality of pixels, and an optical element provided on the sensor board to transmit incident light into each of the plurality of pixels. The plurality of pixels in each of the plurality of unit pixel groups are arranged to have displacement vectors in a direction from a center of a respective unit pixel group, among the plurality of unit pixel groups, to a center of an arrangement of the plurality of pixels in the respective unit pixel group. The plurality of displacement vectors have an irregular distribution in a range of less than or equal to a maximum displacement, and a size of each of a plurality of displacement vectors is equal to or greater than 0.

### CROSS-REFERENCE TO RELATED APPLICATION

This application is based on and claims priority under 35 U.S.C. §119 to Korean Patent Application No. 10-2024-0133254, filed on September 30, 2024, in the Korean Intellectual Property Office, the disclosure of which is incorporated by reference herein in its entirety.

### BACKGROUND

### 1. Field

The disclosure relates to an image sensor and an electronic device including the same.

### 2. Description of the Related Art

A related art image sensor has a structure in which pixels that sense light of different colors are arranged periodically. As such, it may be difficult to obtain information of a same color in all areas of the image sensor. Therefore, the image resolution may deteriorate due to undersampling, and artifacts may occur during image processing to restore lost color information.

Recently, a Foveon image sensor with a structure which can receive all R, G, and B lights in one pixel has been developed. The Foveon image sensor has a structure in which three photodiodes are stacked vertically (e.g., three stacked layers) and incident light is received from the upper photodiode in order of wavelength. For example, a top layer photodiode detects short-wavelength light (e.g., blue), a middle layer photodiode detects medium-wavelength light (e.g., green), and a bottom layer detects long-wavelength light (e.g., red). However, the Foveon image sensor has a disadvantage of large color mixing between RGB. In other words, rather than highly accurate RGB (colors separated into individual color areas on the CIE color chart), a color that is a mixture of red and green, a mixture of green and another color, and a mixture of blue and another color may be obtained.

### SUMMARY

Aspects of the disclosure relate to an image sensor with a structure that reduces artifacts during image processing and an electronic device including the image sensor are provided.

Additional aspects will be set forth in part in the description which follows and, in part, will be apparent from the description, or may be learned by practice of the presented embodiments of the disclosure.

According to an aspect of the disclosure, there is provided an image sensor, including: a sensor board including a plurality of unit pixel groups, each of the plurality of unit pixel groups including a plurality of pixels configured to sense light and arranged two-dimensionally in a first direction and a second direction; and an optical element provided on the sensor board configured to transmit incident light into each of the plurality of pixels, the optical element including a plurality of areas respectively facing the plurality of unit pixel groups, wherein each of the plurality of unit pixel groups includes a red pixel configured to sense light of a first wavelength band, a green pixel configured to sense light of a second wavelength band, and a blue pixel configured to sense light of a third wavelength band, wherein the plurality of pixels in each of the plurality of unit pixel groups are arranged to have displacement vectors in a direction from a center of a respective unit pixel group, among the plurality of unit pixel groups, to a center of an arrangement of the plurality of pixels in the respective unit pixel group, wherein a magnitude of each of a plurality of displacement vectors is equal to or greater than 0, wherein the plurality of displacement vectors have an irregular distribution in a range of less than or equal to a maximum displacement, and wherein the maximum displacement is less than a distance (s) between centers of adjacent pixels in the first direction.

The maximum displacement may be s/√2.

A component dx of the displacement vector in the first direction may be equal to or greater than -s/2 and equal to or less than s/2.

The component dx may be defined in each of the plurality of unit pixel groups and the plurality of dx has a Gaussian distribution in a range from -s/2 to s/2.

A component dy of the displacement vector in the second direction may be equal to or greater than -s/2 and equal to or less than s/2.

The component dy may be defined in each of the plurality of unit pixel groups and has a Gaussian distribution in the range of -s/2 or more and s/2 or less.

A component dy of the displacement vector in the second direction may be defined in each of the plurality of unit pixel groups and the plurality of the component dy has a Gaussian distribution in a range from -s/2 to s/2.

The plurality of unit pixel groups may be grouped into a plurality of groups that are repeatedly arranged, a number of unit pixel groups, among the plurality of unit pixel groups, in each of the plurality of groups is same, and distributions of the displacement vectors within the plurality of groups are same.

The plurality of unit pixel groups may be grouped into a plurality of groups that are repeatedly arranged, and distributions of the displacement vectors are different from each other in two or more of the plurality of groups.

The optical element may include a nano-optical lens array may include a plurality of nanostructures, the nano-optical lens array includes a plurality of unit structures respectively facing the plurality of unit pixel groups, and each of the plurality of unit structures includes a red pixel corresponding area, a green pixel corresponding area, and a blue pixel corresponding area respectively corresponding to the red pixel, the green pixel, and the blue pixel.

The plurality of unit structures may be configured so that light is color-separated and focused within each of the plurality of unit structures independently.

The image sensor may include an optical diffuser provided on the nano-optical lens array.

The image sensor may include a color filter array arranged between the nano-optical lens array and the sensor board.

The red pixel includes a red photodiode configured to selectively absorb light in a red wavelength band, the red pixel having a first width in a cross-section thereof perpendicular to a third direction, the green pixel includes a green photodiode configured to selectively absorb light in a green wavelength band, the green pixel having a second width in a cross-section thereof perpendicular to the third direction, the blue pixel includes a blue photodiode configured to selectively absorb light in a blue wavelength band, the blue pixel having a third width in a cross-section thereof perpendicular to the third direction, and two of the first, second, and third widths are different from each other.

The optical element may include a microlens array including a plurality of microlenses respectively facing the plurality of unit pixel groups.

One unit pixel group may include one red photodiode, two green photodiodes, and one blue photodiode, and wherein the two green photodiodes are located diagonally.

One unit pixel group may include one red photodiode, two blue photodiodes, and one green photodiode, and wherein the two blue photodiodes are located diagonally.

According to an aspect of the disclosure, there is provided an electronic device, including: a lens assembly that forms an optical image of an object; an image sensor configured to convert the optical image formed by the lens assembly into an electrical signal; and a processor configured to process signals generated from the image sensor, wherein the image sensor may include: a sensor board including a plurality of unit pixel groups, each of the plurality of unit pixel groups including a plurality of pixels configured to sense light and arranged two-dimensionally in a first direction and a second direction; and an optical element provided on the sensor board configured to transmit incident light into each of the plurality of pixels, the optical element including a plurality of areas respectively facing the plurality of unit pixel groups, wherein each of the plurality of unit pixel groups includes a red pixel configured to sense light of a first wavelength band, a green pixel configured to sense light of a second wavelength band, and a blue pixel configured to sense light of a third wavelength band, wherein the plurality of pixels in each of the plurality of unit pixel groups are arranged to have displacement vectors in a direction from a center of a respective unit pixel group, among the plurality of unit pixel groups, to a center of an arrangement of the plurality of pixels in the respective unit pixel group, wherein a size of each of a plurality of displacement vectors is equal to or greater than 0, wherein the plurality of displacement vectors have an irregular distribution in a range of less than or equal to a maximum displacement, and wherein the maximum displacement is less than a distance (s) between centers of adjacent pixels in the first direction.

The optical element may include a nano-optical lens array including a plurality of nanostructures, the nano-optical lens array may include a plurality of unit structures respectively facing the plurality of unit pixel groups, and each of the plurality of unit structures may include a red pixel corresponding area corresponding to the red pixel, a green pixel corresponding area corresponding to the green pixel, and a blue pixel corresponding area respectively corresponding to the blue pixel.

The red pixel may include a red photodiode configured to selectively absorb light in a red wavelength band, the red pixel having a first width in a cross-section thereof perpendicular to a third direction, the green pixel may include a green photodiode configured to selectively absorb light in a green wavelength band, the green pixel having a second width in a cross-section thereof perpendicular to the third direction, the blue pixel may include a blue photodiode configured to selectively absorb light in a blue wavelength band, the blue pixel having a third width in a cross-section thereof perpendicular to the third direction, and two of the first, second, and third widths are different from each other.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a schematic block diagram of an image sensor, according to an embodiment;

FIG. 2A is a plan view illustrating a color arrangement represented by a pixel array of an image sensor, according to an embodiment;

FIG. 2B is a plan view illustrating a pixel arrangement of a sensor board provided in a pixel array of an image sensor, according to an embodiment;

FIG. 2C is a plan view illustrating a nano-optical lens array provided in a pixel array of an image sensor, according to an embodiment;

FIGS. 3A and 3B are different schematic cross-sectional views of a pixel array of an image sensor, according to an embodiment;

FIG. 4 is a plan view illustrating a pixel arrangement of a sensor board provided in a pixel array of an image sensor, according to an embodiment;

FIGS. 5A to 5E are plan views showing unit pixel groups and displacement vectors defined therein at different positions of the sensor board in FIG. 4;

FIGS. 6A and 6B are graphs illustrating a distribution of x and y components of a displacement vector defined in a unit pixel group of a sensor board provided in a pixel array of an image sensor, according to an embodiment;

FIG. 7 is a plan view of a sensor board provided in a pixel array of an image sensor, according to another embodiment;

FIG. 8 is a cross-sectional view of a pixel array of an image sensor, according to another embodiment;

FIG. 9 is a schematic perspective view showing the configuration of a pixel array of an image sensor, according to another embodiment;

FIGS. 10A and 10B are cross-sectional views taken along line A-A’ and line B-B’ in FIG. 9, respectively;

FIG. 11 is a plan view illustrating a pixel arrangement of a sensor board provided in the image sensor in FIG. 9;

FIGS. 12A to 12C are plan views showing unit pixel groups and displacement vectors defined therein at different positions of the sensor board in FIG. 11;

FIG. 13 is a plan view showing a unit pixel group of a sensor board provided in a pixel array of an image sensor, according to another embodiment;

FIG. 14 is a schematic block diagram of an electronic device including an image sensor, according to an embodiment;

FIG. 15 is a schematic block diagram of a camera module included in the electronic device in FIG. 14;

FIG. 16 is a block diagram of an electronic device including a multi-camera module; and

FIG. 17 is a detailed block diagram of one camera module included in the electronic device of FIG. 16.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments are described in detail with reference to the accompanying drawings. The described embodiments are merely illustrative, and various modifications are possible from these embodiments. The same reference numerals in the following drawings refer to the same components, and the size of each component in the drawings may be exaggerated for clarity and convenience of description.

Hereinafter, terms, such as “above” or “on”, may include what is directly above in contact as well as what is above without contact.

Terms, such as first, second, and the like, may be used to describe various components, but are only used for the purpose of distinguishing one component from another. These terms do not limit the nature or structure of the components.

Singular expressions include plural expressions unless the context clearly dictates otherwise. In addition, when a part is said to “include” a certain component, it means that the part may further include other components, rather than excluding other components, unless otherwise specified.

According to one or more embodiments, various operations and/or functions described below may be implemented in a hardware approach. For example, according to some embodiments, the methods described below may be implemented by an electronic device configured to carry out a described operation(s) or function(s). The electronic device may include blocks, which may be referred to herein as managers, units, modules, hardware components, “~er” terms or the like, may be physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure. However, the disclosure is not limited thereto, and as such, the blocks, which may be referred to herein as managers, units, modules, or the like, may be software modules implemented by software codes, program codes, software instructions, or the like. The software modules may be executed on one or more processors. According to an embodiment, the “module” may be a minimum unit of an integrally formed component or part thereof. The “module” may be a minimum unit for performing one or more functions or part thereof. The “module” may be implemented mechanically or electronically.

The use of the term “the” and similar referential terms may refer to both the singular and the plural.

According to one or more embodiments, operations constituting a method may be performed in any suitable order unless explicitly stated that they must be performed in the order described. In addition, the use of all exemplary terms (e.g., and the like) is intended merely to describe the inventive concept in detail. The scope of rights is not limited by these terms unless limited by the claims.

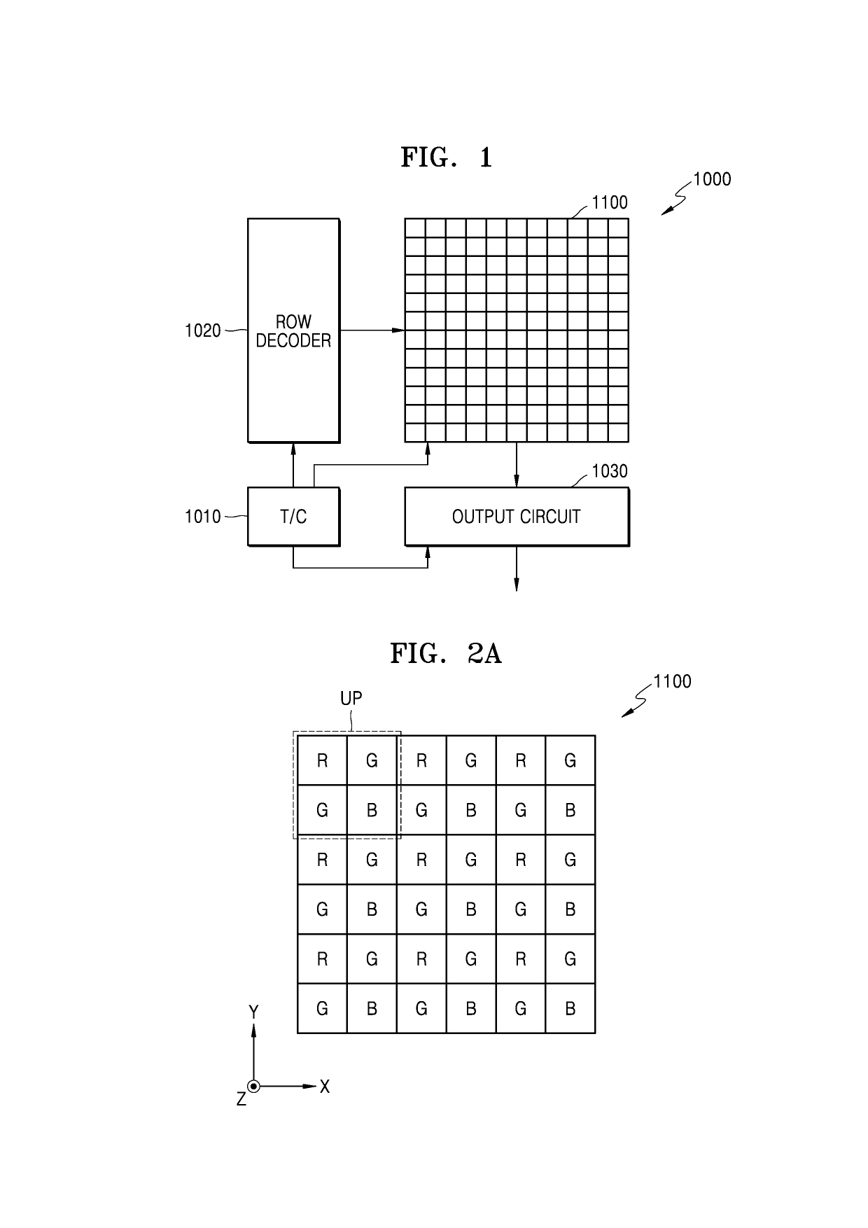

FIG. 1 is a schematic block diagram of an image sensor, according to an embodiment. Referring to FIG. 1, an image sensor 1000 may include a pixel array 1100, a timing controller (T/C) 1010, a row decoder 1020, and an output circuit 1030. However, the disclosure is not limited thereto, and as such, according to an embodiment, the image sensor may include one or more additional components. The image sensor 1000 may include a charge-coupled device (CCD) image sensor or a complementary metal-oxide semiconductor (CMOS) image sensor.

The pixel array 1100 may include pixels arranged two-dimensionally along a plurality of rows and a plurality of columns. The row decoder 1020 may select one of the rows of the pixel array 1100 based on a row address signal output from the timing controller 1010. For example, the row decoder 1020 may select one of the rows of the pixel array 1100 in response to a row address signal output from the timing controller 1010. The output circuit 1030 may output light sensing signals in column units from a plurality of pixels arranged along the selected row. To this end, the output circuit 1030 may include a column decoder and an analog-to-digital converter (ADC). For example, the output circuit 1030 may include a plurality of ADCs arranged for each column between the column decoder and the pixel array 1100, or one ADC arranged at an output end of the column decoder. The timing controller 1010, the row decoder 1020, and the output circuit 1030 may be implemented as one chip or separate chips. A processor for processing an image signal output through the output circuit 1030 may be implemented as one chip together with the timing controller 1010, the row decoder 1020, and the output circuit 1030.

The pixel array 1100 may include a plurality of pixels that sense light of different wavelengths. The arrangement of the pixels may be implemented in various ways.

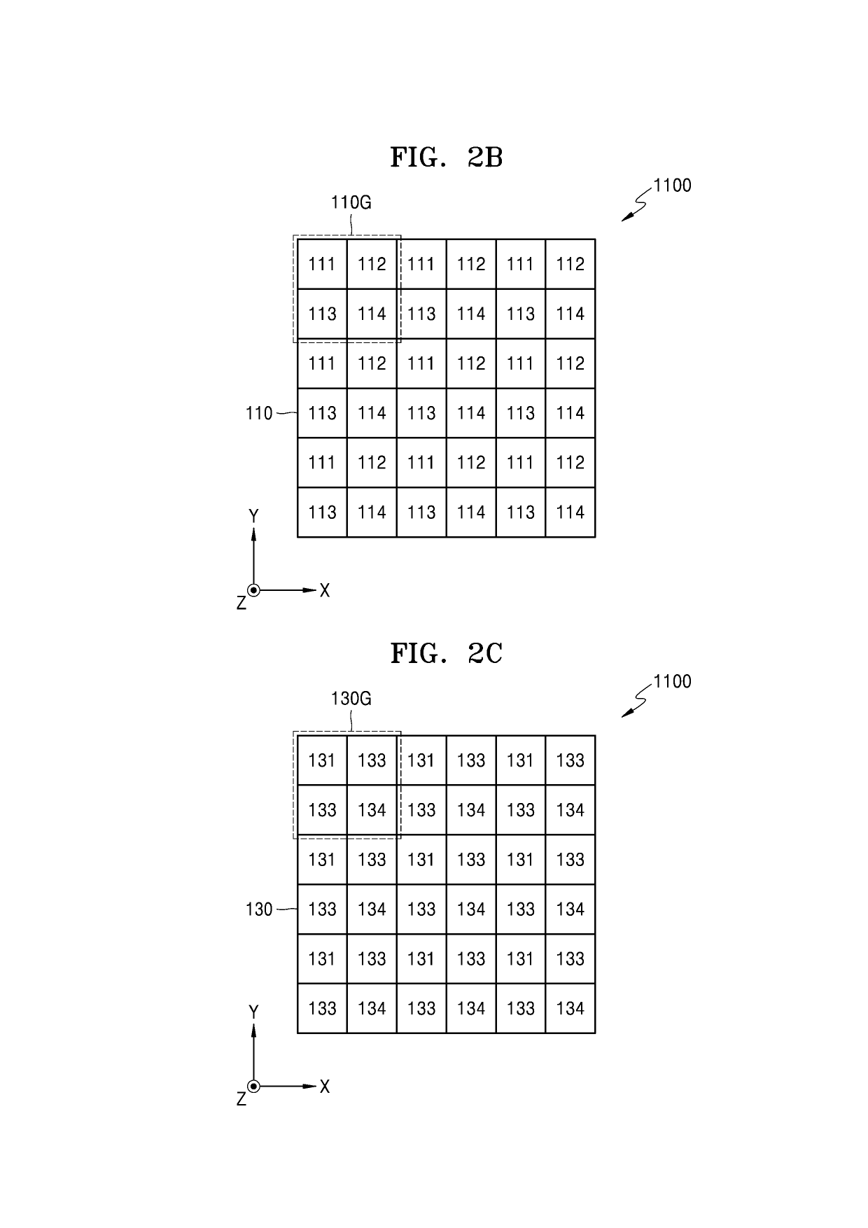

FIG. 2A is a plan view illustrating a color arrangement represented by the pixel array 1100 of the image sensor 1000, according to an embodiment.

FIG. 2A shows a color arrangement of a Bayer pattern. A unit pattern UP is repeatedly arranged in two dimensions in a first direction (X direction) and a second direction (Y direction). The unit pattern UP includes a pattern in which red (R), green (G), green (G) and blue (B) are arranged in the form of a 2×2 array in the first direction (X direction) and the second direction (Y direction).

The color arrangement in FIG. 2A is only an example and the disclosure is not limited thereto. For example, a CYGM arrangement in which magenta, cyan, yellow, and green may be provided in one unit pattern UP, or an RGBW arrangement in which green, red, blue, and white may be provided in one unit pattern UP may be used. In addition, the unit pattern UP may be implemented in the form of a 3×2 array or another form or array with different dimensions. In addition, the pixels of the pixel array 1100 may be arranged in various ways according to the color characteristics of the image sensor 1000. Hereinafter, a color arrangement based on red (R), green (G), and blue (B) is shown as an example. However, other types of color arrangement are also possible.

The pixel array 1100 of the image sensor 1000 may include a sensor board having unit pixel groups respectively corresponding to unit patterns of the color arrangement shown in FIG. 2A, and an optical element for focusing incident light into each pixel. The optical element may include, for example, a nano-optical lens array that separates incident light according to wavelength and focuses the separated light into a corresponding pixel.

FIG. 2B is a plan view illustrating a sensor board provided in a pixel array of an image sensor, according to an embodiment, and FIG. 2C is a plan view illustrating a nano-optical lens array provided in a pixel array of an image sensor, according to an embodiment;

Referring to FIG. 2B, the pixel array 1100 may include a sensor board 110. According to an embodiment, the sensor board 110 may include a plurality of pixels that sense incident light, for example, convert incident light into an electrical signal to generate an image signal. The sensor board 110 may include a plurality of unit pixel groups 110G. The unit pixel groups 110G correspond one-to-one with the unit patterns UP shown in FIG. 2A. The unit pixel groups 110G include a first pixel 111, a second pixel 112, a third pixel 113, and a fourth pixel 114. The first pixel 111, the second pixel 112, the third pixel 113, and the fourth pixel 114 are arranged in the form of a 2×2 array in the first direction (X direction) and the second direction (Y direction).

The pixel arrangement of the sensor board 110 is for sensing incident light by dividing the light into colors of the arrangement as shown in FIG. 2A. The second pixel 112 and the third pixel 113 may correspond to green light, the first pixel 111 may correspond to red light, and the fourth pixel 114 may correspond to blue light. Hereinafter, the first pixel may include a red pixel, the second pixel may include a first green pixel, the third pixel may include a second green pixel, and the fourth pixel may include a blue pixel. However, the disclosure is not limited thereto, and as such, the sensor board 110 may have a different arrangement of pixels.

Each of the illustrated pixels may include a light sensing cell that senses incident light. For example, each of the illustrated pixels may include a light sensing cell that independent senses incident light. One pixel may be partitioned into two or more light sensing cells. Some pixels may only be utilized for generating an autofocus signal and may not be utilized as independent image pixels. However, this is only an example and is not limited thereto. Each of the plurality of pixels may be utilized both for generating an image signal and for generating an autofocus signal.

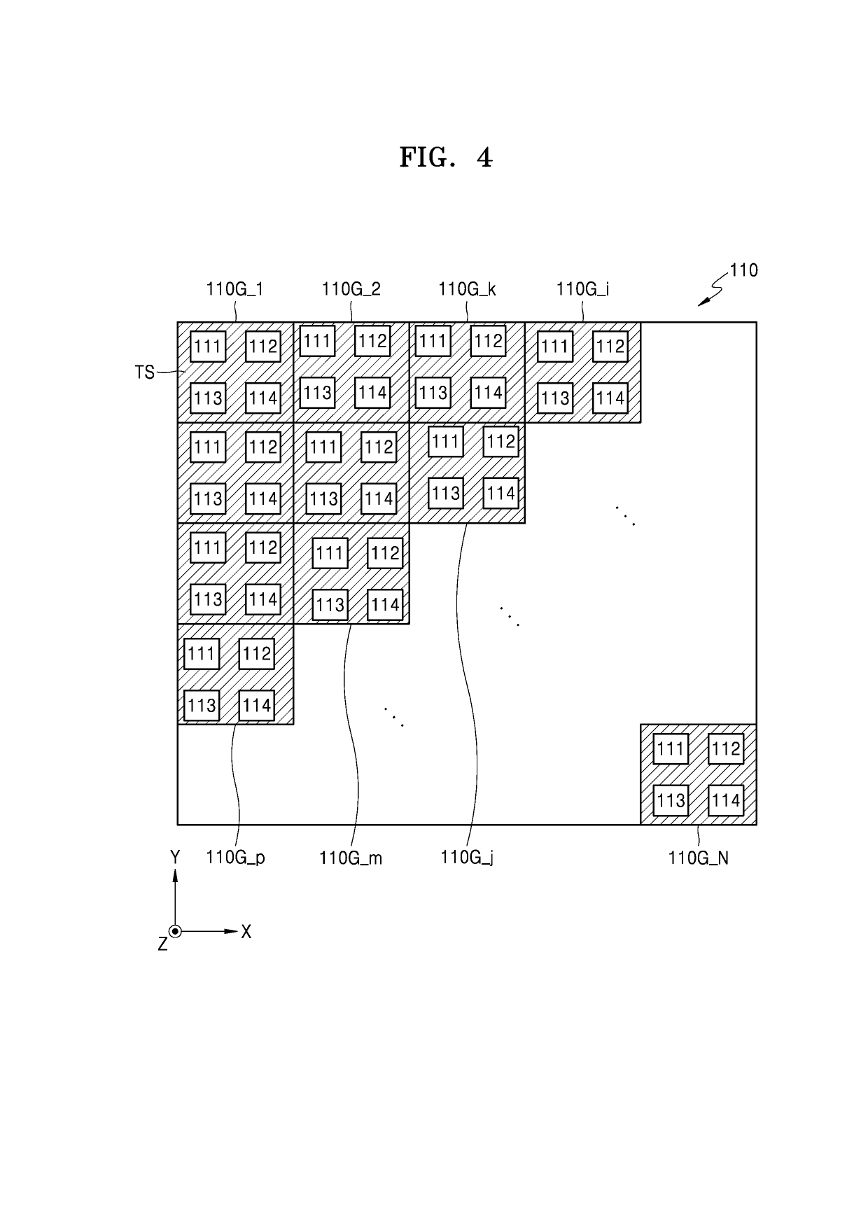

The adjacent pixels may be electrically separated by an isolation structure. Although shown simply as a line in the drawings, the isolation structure may have a physical thickness. For example, the isolation structure may be formed as a deep trench isolation (DTI) structure. The DTI structure may be filled with air or an electrically insulating material. After a light sensing layer is formed, the isolation structure may be formed on the light sensing layer to form a plurality of electrically isolated light sensing cells. The physical thickness of the isolation structure may vary depending on the location thereof. In an embodiment, the positions of light sensing cells included in the unit pixel group 110G may vary and may have an irregular or random distribution. This may be explained in detail with reference to FIGS. 4 to 6B.

Referring to FIG. 2C, the pixel array 1100 may include a nano-optical lens array 130. For example, the nano-optical lens array 130 may include a plurality of unit structures 130G respectively corresponding to the plurality of unit pixel groups 110G of the sensor board 110. For example, each of the plurality of unit structures 130G may include a plurality of pixel corresponding areas. The unit structure 130G may include a first pixel corresponding area 131 facing the first pixel 111, a second pixel corresponding area 132 facing the second pixel 112, a third pixel corresponding area 133 facing the third pixel 113, and a fourth pixel corresponding area 134 facing the fourth pixel 114. The first to fourth pixel corresponding areas 131, 132, 133, and 134 may be interchangeably referred to as a red pixel corresponding area, a first green pixel corresponding area, a second green pixel corresponding area, and a blue pixel corresponding area, respectively. However, the disclosure is not limited thereto, and as such, the nano-optical lens array 130 may have a different arrangement of pixel corresponding areas.

In each of the plurality of pixel corresponding areas, nano-posts are provided. The division of areas of the nano-optical lens array 130 and the shape and arrangement of the nano-posts provided in each area of the nano-optical lens array 130 may be set to form a phase profile that separates incident light according to the wavelength and focuses the incident light into the facing pixels. Depending on the shape and arrangement of the plurality of nano-posts provided in each of the first to fourth pixel corresponding areas 131, 132, 133, and 134, the incident light may be separated according to the wavelength and focused into the pixels provided in the sensor board 110. Hereinafter, color separation in the visible light band is described, but is not limited thereto. The wavelength band may be extended to a range of visible light to infrared light, or various other ranges.

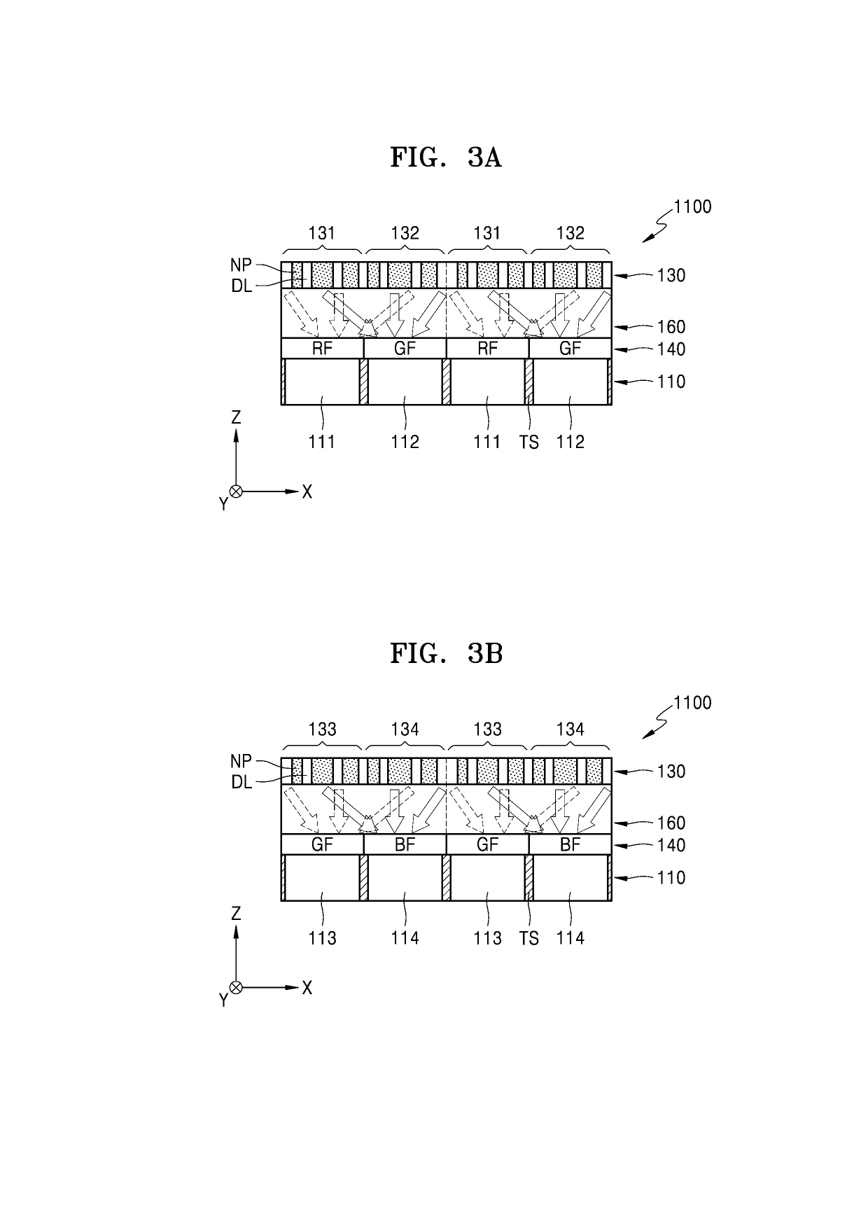

FIGS. 3A and 3B are different schematic cross-sectional views of a pixel array of an image sensor, according to an embodiment.

Referring to FIGS. 3A and 3B, the pixel array 1100 includes a sensor board 110 having a plurality of light sensing cells that sense light and an optical element that transmits light into each of the plurality of light sensing cells of the sensor board 110. For example, the optical element may separate and focus light into each of the plurality of light sensing cells of the sensor board 110. The optical element may include a nano-optical lens array 130. A spacer layer 160 may be arranged between the nano-optical lens array 130 and the sensor board 110.

The light sensing cells provided in the sensor board 110 may be referred to as a first pixel 111, a second pixel 112, a third pixel 113, and a fourth pixel 114, depending on the color of incident light. The first pixel 111, the second pixel 112, the third pixel 113, and the fourth pixel 114 may sense red light, green light, green light, and blue light, respectively. Hereinafter, the first pixel 111, the second pixel 112, the third pixel 113, and the fourth pixel 114 may be used interchangeably as red light, green light, green light, and blue light, respectively. However, the disclosure is not limited thereto.

According to an embodiment, a partition structure TS may be formed between adjacent first to fourth pixels 112, 112, 113 and 114. For example, the partition structure TS may electrically separate the first to fourth pixels 111, 112, 113, and 114. In addition, all or some of the first to fourth pixels 111, 112, 113, and 114 may be partitioned into a plurality of light sensing cells, for example, four light sensing cells, respectively. As such, in an example case in which the first to fourth pixels 111, 112, 113, and 114 are partitioned into a plurality of light sensing cells, respectively, signals from the light sensing cells may be used as autofocus signals or may be used for binning mode operation to increase sensitivity in a low-light environment.

The spacer layer 160 is arranged between the sensor board 110 and the nano-optical lens array 130 to keep the spacing between the sensor board 110 and the nano-optical lenses array 130 constant. The spacer layer 160 may include a transparent material to visible light, for example, a dielectric material having a lower refractive index and a lower absorption rate in the visible light band than a nanostructure NP described below. For example, the dielectric material may include, but is not limited to, poly methyl methacrylate (PMMA), silanol-based spin-on-glass (SOG), SiO₂, Si₃N₄, Al₂O₃, and the like.

The nano-optical lens array 130 may be provided on the spacer layer 160. According to an embodiment, other layers or components may be provided between the sensor board 110 and the nano-optical lens array 130 For example, an etch stop layer may be further provided between the spacer layer 160 and the nano-optical lens array 130 to protect the spacer layer 160 in the process of forming the nano-optic lens array 130.

The nano-optical lens array 130 may include a plurality of first pixel corresponding areas 131 corresponding to the plurality of first pixels 111, a plurality of second pixel corresponding areas 132 corresponding to the plurality second pixels 112, a plurality of third pixel corresponding areas 133 corresponding to the plurality third pixels 113, and a plurality of fourth pixel corresponding areas 134 corresponding to the plurality fourth pixels 114. The first pixel corresponding area 131 may be arranged to face the first pixel 111 in the third direction (Z direction), the second pixel corresponding area 132 may be arranged to face the second pixel 112 in the third direction (Z direction), the third pixel corresponding area 133 may be arranged to face the third pixel 113 in the third direction (Z direction), and the fourth pixel corresponding area 134 may be arranged to face the fourth pixel 114 in the third direction (Z direction).

According to an embodiment, the nano-optical lens array 130 may be configured to color separate the incident light. For example, the nano-optical lens array 130 may separate the incident light into light of a first wavelength band (e.g., red light), light of a second wavelength band (e.g., green light), and light of a third wavelength band (e.g., blue light), thereby causing the lights to traverse through different paths. In addition, the nano-optical lens array 130 may be configured to function as a lens that focuses the color-separated lights of the first wavelength band, the second wavelength band, and the third wavelength band into the pixels. For example, from the incident light, the nano-optical lens array 130 may be configured to focus green light into the second pixel 112 and the third pixel 113, red light into the first pixel 111, and blue light into the fourth pixel 114.

In addition, with the nano-optical lens array 130 according to an embodiment, color separation and light focusing may occur for each unit structure 130G, that is, independently in each of the plurality of unit structures 130G. In other words, light incident on any one of the plurality of unit structures 130G is color-separated only in the corresponding unit structure 130G and is focused only into a pixel corresponding to a pixel corresponding area in the unit structure 130G, and each unit structure 130G does not affect color separation and light focusing on other adjacent unit structures 130G. For example, green light of the light incident on one unit structure 130G is only focused into the second pixel 112 and the third pixel 113 respectively corresponding to the second pixel corresponding area 132 and the third pixel corresponding area 133 included in the unit structure 130G and is not focused into the second pixel 112 and the third pixel 113 corresponding to another adjacent unit structure 130G. Similarly, blue light of the light incident on one unit structure 130G is only focused into the fourth pixel 114 corresponding to the fourth pixel corresponding area 134 included in the unit structure 130G and is not focused on the fourth pixel 114 corresponding to another adjacent unit structure 130G, and red light of the light incident on one unit structure 130G is focused only into the first pixel 111 corresponding to the first pixel corresponding area 131 of the unit structure 130G and is not focused into the first pixel 111 corresponding to another adjacent unit structure 130G. As such, adjacent unit structures 130G are optically separated from each other such that no exchange of light or energy occurs therebetween. As described above, the light that is color separated and focused within one unit structure includes only the spatial information of the light incident on the unit structure and does not include the spatial information of the light incident on other adjacent unit structures. The output of pixels of a unit corresponding to one unit structure of the nano-optical lens array 130 may all have the same spatial information regardless of color. For example, green light signals output from the second pixel 112 and the third pixel 113, a blue light signal output from the fourth pixel 114, and a red light signal output from the first pixel 111, each corresponding to one unit structure 130G, may all have the same spatial information. In this case, all of the green light signals, blue light signals, and red light signals output from the entire pixels of the image sensor 1000 or the pixel array 1100 may have spatial information on the entire area of the image sensor 1000 or the pixel array 1100, without any empty space. Therefore, computation, such as demosaicing or color filter array interpolation, for filling the empty space information between the same color pixels in the related art image sensor may be omitted during an image processing process for generating an image by using signals output from the image sensor 1000, according to an embodiment. Accordingly, the amount of computation and power consumption of an image signal processing processor of an apparatus including the image sensor 1000 or a processor in the image sensor 1000 may be reduced.

The nano-optical lens array 130 may include a plurality of nanostructures NPs periodically arranged according to a certain rule. One or more nanostructures NPs may be arranged in each of the plurality of first pixel corresponding areas 131, the plurality of second pixel corresponding areas 132, the plurality of third pixel corresponding areas 133, and the plurality of fourth pixel corresponding areas 134 included in the nano-optical lens array 130. The arrangement of nanostructures NPs is shown in FIGS. 3A and 3B for convenience of explanation.

The nano-optical lens array 130 may further include a dielectric layer DL between the plurality of nanostructures NPs spaced apart from each other. In order for the nano-optical lens array 130 to perform the functions described above, the plurality of nanostructures NPs of the nano-optic lens array 130 may be variously configured. For example, the plurality of nanostructures NPs may be arranged to vary the phase of light transmitted through the nano-optical lens array 130 differently depending on the position on the nano-optic lens array 130. The phase profile of the transmitted light implemented by the nano-optical lens array 130 may be determined depending on the cross-sectional size (e.g., width or diameter), the cross-sectional shape, and the height of each nanostructure NP, and the spacing, the arrangement period (or pitch), and the arrangement form of the plurality of nanostructures NPs. In addition, the behavior of the light transmitted through the nano-optical lens array 130 may be determined depending on the phase profile of the transmitted light.

The nanostructure NP may have a size that is less than the wavelength of visible light. The nanostructure NP may have a size that is less than, for example, a wavelength of blue light. For example, the cross-sectional width (or diameter) of the nanostructure NP may be less than 400 nm, 300 nm, or 200 nm and greater than about 80 nm. The height of the nanostructure NP, that is, the length of the nanostructure NP in the third direction (Z direction), may be about 500 nm to about 1500 nm, and may be greater than the width of the cross-section of the nanostructure NP.

The nanostructure NP may include a material that has a relatively high refractive index and a relatively low absorption rate in the visible light band, compared to the surrounding material. For example, the nanostructure NP may include, but is not limited to, c-Si, p-Si, a-Si, III-V compound semiconductors), SiC, TiO₂, SiN₃, ZnS, ZnSe, Si₃N₄, and/or combinations thereof. The III-V compound semiconductors may include, but is not limited to, GaP, GaN, or GaAs. The area around the nanostructure NP may be filled with the dielectric layer DL (or dielectric material) that has a relatively lower refractive index and a relatively lower absorption rate in the visible light band than the nanostructure NP. For example, the dielectric layer DL may be filled with material including, but not limited to, PMMA, SOG, SiO₂, Si₃N₄, Al₂O₃, air, and the like.

The refractive index of the nanostructure NP may be about 2.0 or more for light of about 630 nm wavelength, and the refractive index of the dielectric layer DL may be about 1.0 or more and less than 2.0 for light of about 630 nm wavelength. In addition, the difference between the refractive index of the nanostructure NP and the refractive index of the dielectric layer DL may be about 0.5 or more. The nanostructure NP having a refractive index difference from the surrounding material may change the phase of light passing through the nanostructure NP. This is due to the phase delay caused by the shape dimension of the sub-wavelength of the nanostructure NP, and the degree of the phase delay is determined by the detailed shape dimension, and the arrangement form of the nanostructure NP.

According to an embodiment, a color filter array 140 may be arranged between the sensor board 110 and the spacer layer 160. The color filter array 140 includes a red filter RF, a green filter GF, a green filter GF, and a blue filter BF that face the first pixel corresponding area 131, the second pixel corresponding area 132, the third pixel corresponding area 133, and the fourth pixel corresponding area 134, respectively, illustrated with reference to FIG. 2C. The arrangement of the red filter RF, the green filter GF, the green filter GF, and the blue filter BF corresponds to the color arrangement described with reference to FIG. 2A.

Each of the red filter RF, the green filter GF, and the blue filter BF includes a filter that transmits only light of the corresponding color from the incident light. The colored light separated by the nano-optical lens array 130 is incident on each color filter of the color filter array 140. Therefore, the color purity of the colored light incident on the sensor board 110 may be increased by the color filter array 140. The color filter array 140 may be omitted.

As such, in an example case in which the RGB image is obtained from the signals sensed by the pixels of the sensor board 110, a process of sampling only the corresponding color at the position of the first to fourth pixels 111, 112, 113, and 114 in the unit pixel group 110G is performed. The centers of the sampled pixels are spaced apart from each other in different directions for each color, wherein this spacing is indicated by a phase shift. However, the phase shift may cause a false color. In addition, due to down-sampling in a structure having the phase shift, aliasing, such as a Moire pattern, may be shown. The resolution may be reduced by image interpolation processing to remove the false color, aliasing, and the like.

The image sensor according to an embodiment provides a structure in which the position of pixels is not constant and is finely adjusted in a unit pixel group so that aliasing due to down-sampling may be reduced as much as possible.

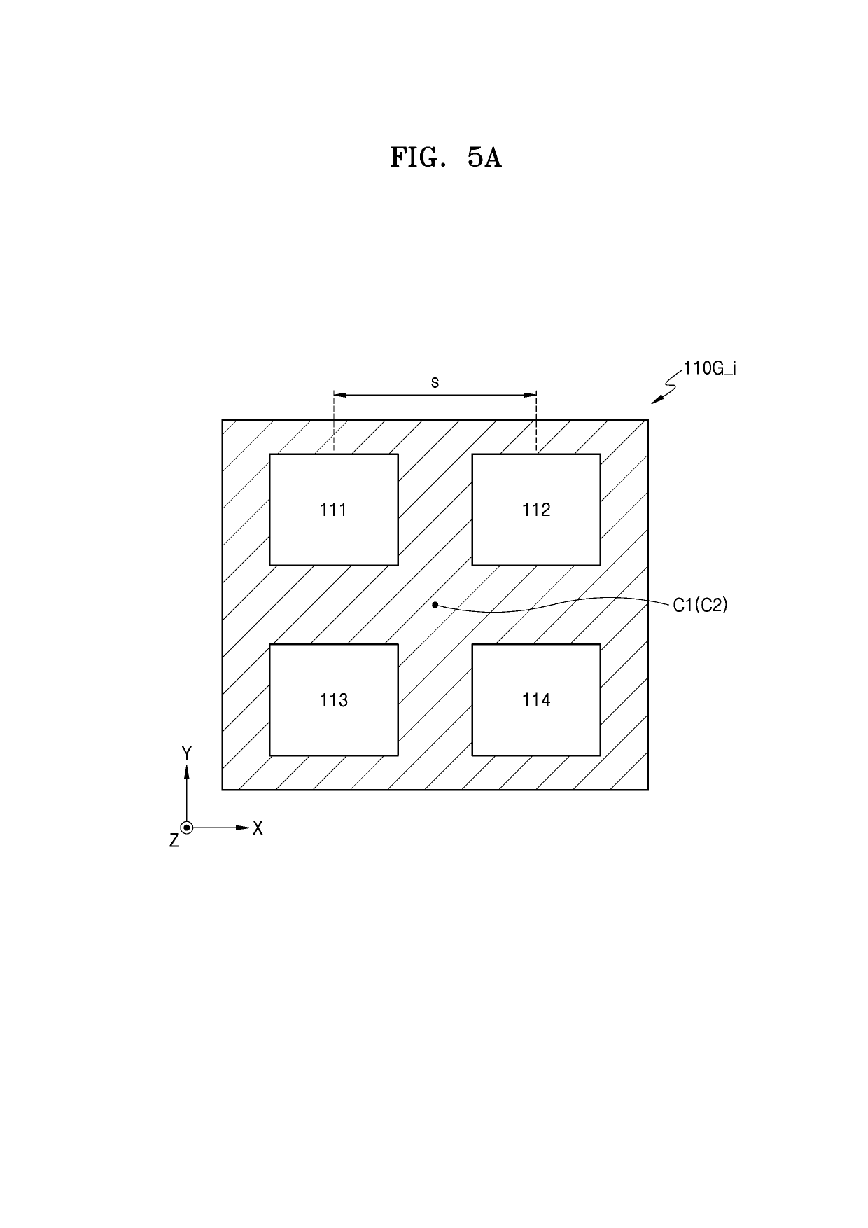

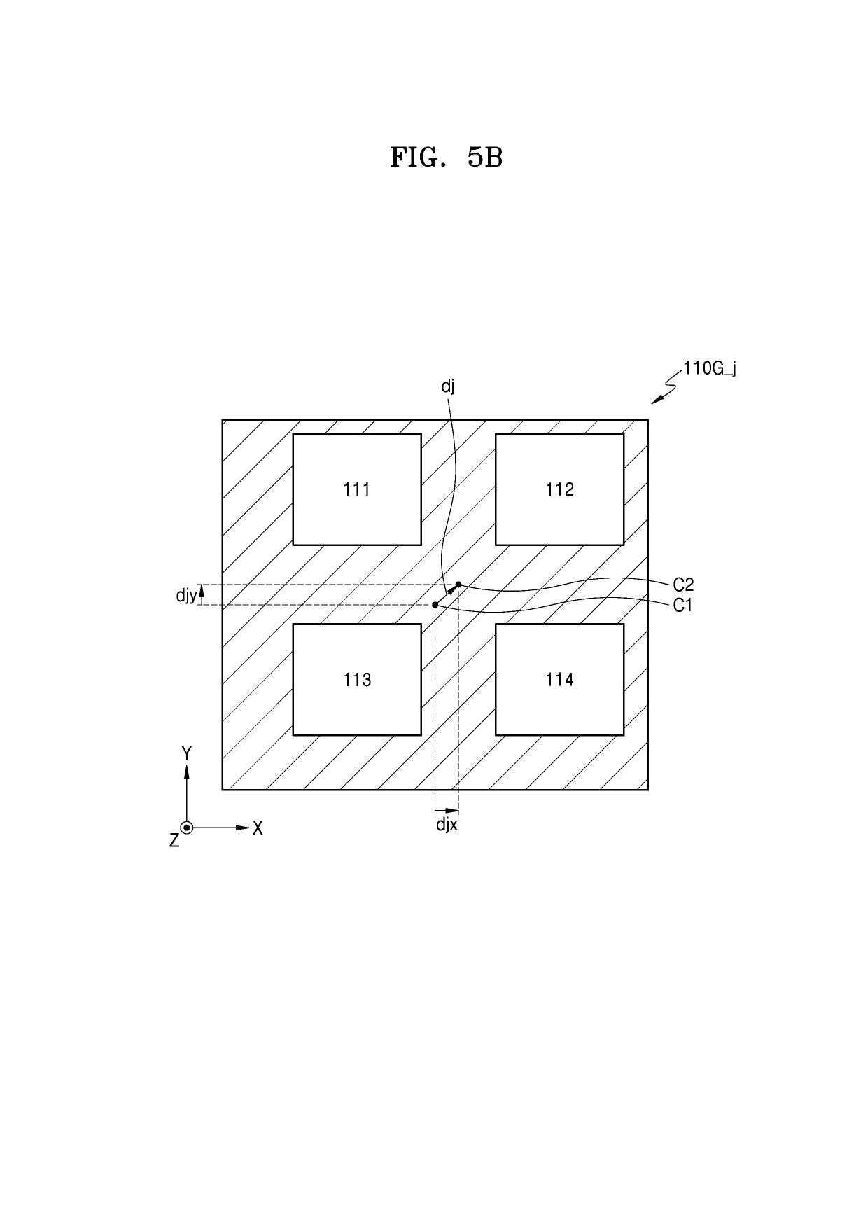

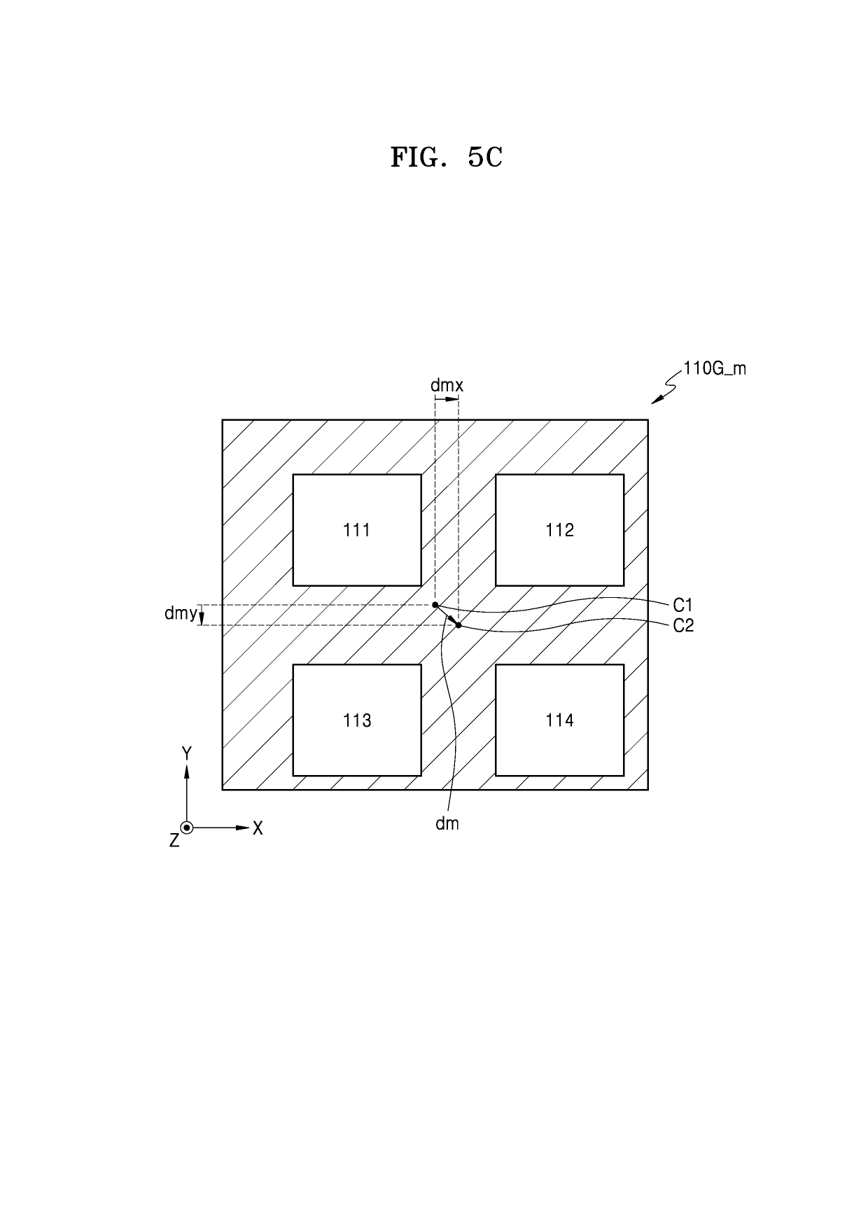

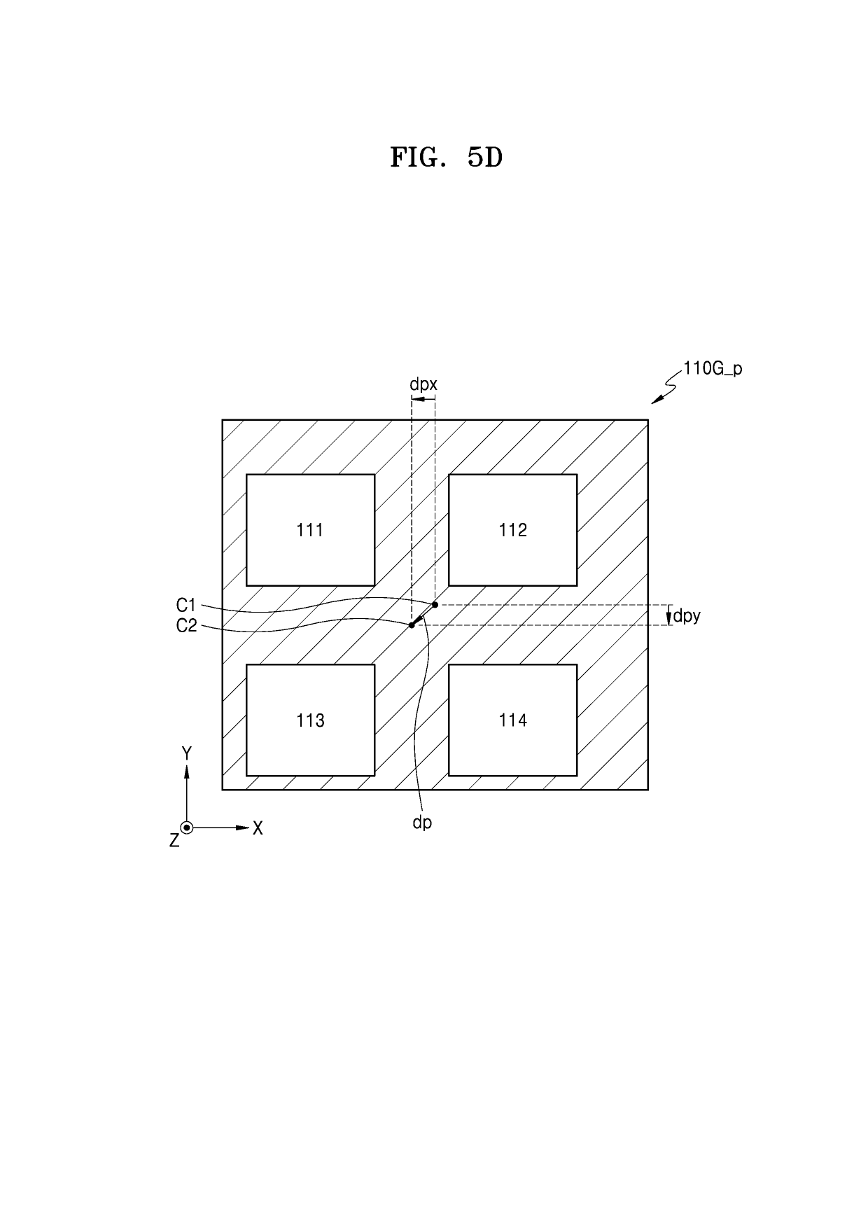

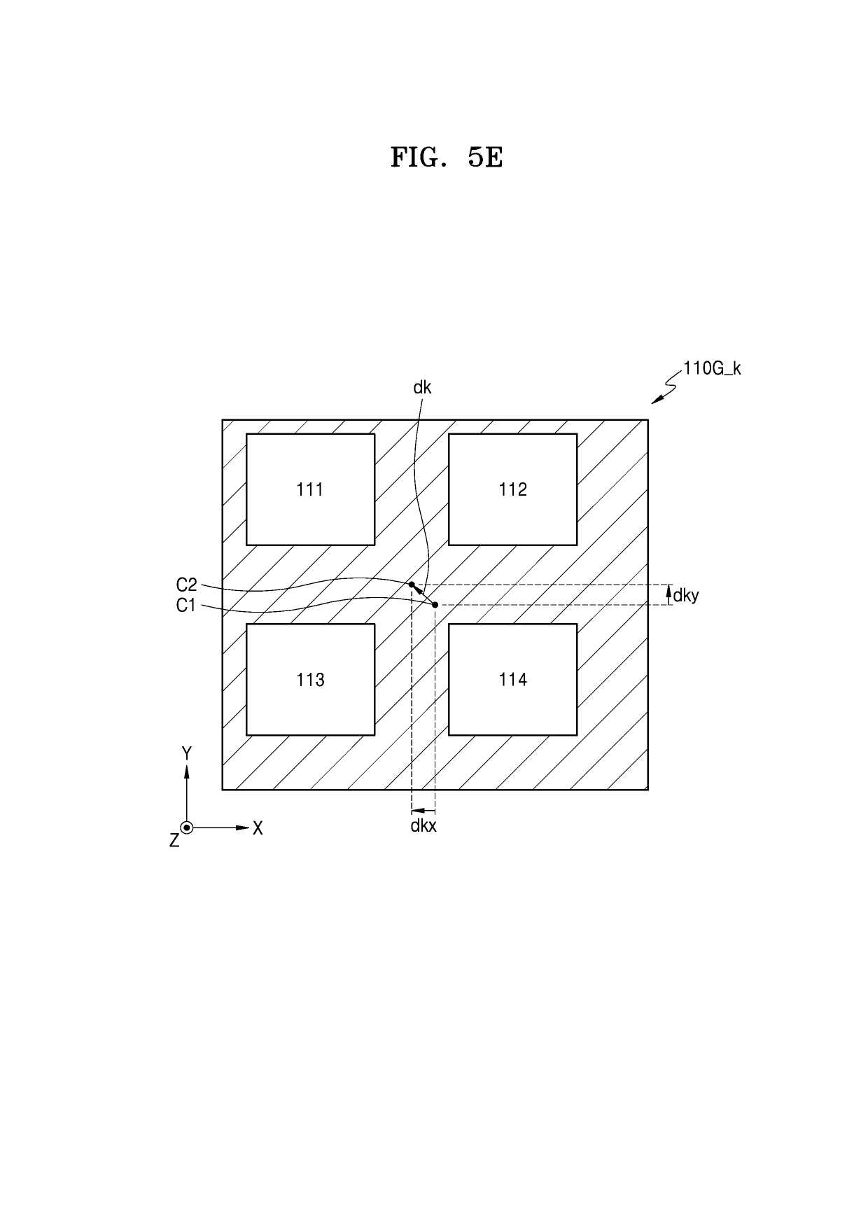

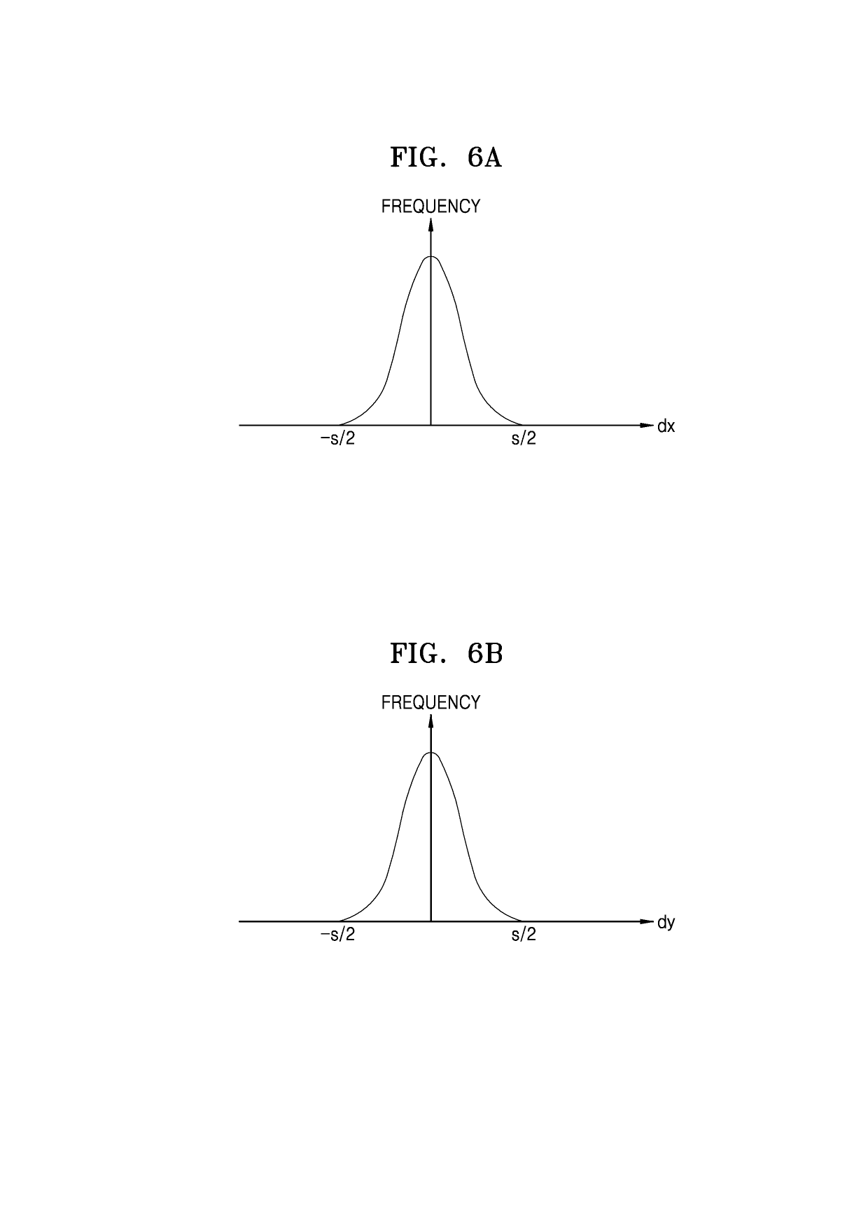

FIG. 4 is a plan view illustrating a pixel arrangement of a sensor board provided in a pixel array of an image sensor, according to an embodiment; FIGS. 5A to 5E are plan views showing unit pixel groups and displacement vectors defined therein at different positions of the sensor board in FIG. 4; and FIGS. 6A and 6B are graphs illustrating the distribution of x and y components of a displacement vector defined in a unit pixel group of a sensor board provided in a pixel array of an image sensor, according to an embodiment.

In FIG. 4, a plurality of unit pixel groups 110G included in the sensor board 110 are indicated by indexes (for example, unit pixel group 110G_1, to unit pixel group 110G_N), depending on the position, where N is an integer.

Depending on the position of the unit pixel group 110G, the relative positions of the first to fourth pixels 111, 112, 113, and 114 in the unit pixel group 110G may be different from each other. For example, the positions of first to fourth pixels 111, 112, 113, and 114 in the unit pixel group 110G_i may be different from the positions of first to fourth pixels 112, 112, 113 and 114 in the unit pixel group 110G_j.

In FIGS. 5A to 5E, a first center C1 indicates a center of the unit pixel group 110G, and a second center C2 indicates a center of an arrangement of the first to fourth pixels 111, 112, 113, and 114 included in the unit pixel group 110G. The first center C1 may be described as a position facing a center of the unit structure 130G of the nano-optical lens array 130, within the unit pixel group 110G,. The first to fourth pixels 111, 112, 113, and 114 may be spaced from the first center C1 by a certain displacement. For example, the first to fourth pixels 111, 112, 112, and 114 in one unit pixel group 110G may be spaced from the first center C1 by the same displacement. Thus, a displacement vector in the unit pixel group 110G may be defined as a vector from the first center C1 to the second center C2.

Referring to FIG. 5A, a displacement vector in the unit pixel group 110G_i is 0, that is, the first center C1 and the second center C2 coincide.

Referring to FIG. 5B, in the unit pixel group 110G_j, a displacement vector dj has an X-direction component of djx and a Y-direction component of djy.

Referring to FIG. 5C, in the unit pixel group 110G_m, a displacement vector dm has an X-direction component of dmx and a Y-direction component of −dmy.

Referring to FIG. 5D, in the unit pixel group 110G_p, a displacement vector dp has an X-direction component of −dpx, and a Y-direction component of −dpy.

Referring to FIG. 5E, in the unit pixel group 110G_k, a displacement vector dk has an X-direction component of −dkx, and a Y-direction component of dky.

The displacement vectors described with reference to FIGS. 5A to 5E are only examples. The displacement vectors in the plurality of unit pixel groups 110G in the sensor board 110 may have an irregular distribution in a size range of less than or equal to the maximum displacement. The maximum displacement is a distance between the centers of adjacent pixels. The maximum displacement may be, for example, a distance s between the centers of the first pixel 111 and the second pixel 112. According to an embodiment, the maximum displacement may be s/√2. The direction of the displacement vector may also be radially random.

Referring to FIG. 6A, the x component, dx, of the displacement vector may be −s/2 or greater and s/2 or less. The dx defined in each of the plurality of unit pixel groups may have a Gaussian distribution in a range of −s/2 or more and s/2 or less.

Referring to FIG. 6B, the y component, dy, of the displacement vector may be equal to or greater than −s/2 and equal to or less than s/2. The dy defined in each of the plurality of unit pixel groups may have a Gaussian distribution in a range of −s/2 or more and s/2 or less.

The graphs of FIGS. 6A and 6B are only examples. The graphs of FIGS. 6A and 6B may be modified differently. For example, the graphs may have various forms with changes in the half width. Additionally, dx and dy may have various types of random distributions within the above range.

As such, with the structure in which the pixel positions are finely adjusted for each unit pixel group 110G, an effect similar to that of non-constant and irregular sampling may be exhibited during down-sampling to generate an RGB image signal. Similar to the fact that Moire does not occur near the Nyquist frequency of the optic nerve cells of the human eye, aliasing may be reduced by adjusting the pixel positions as described above.

As described above, the image sensor 1000, according to an embodiment, may perform the image processing without demosaicing owing to the nano-optical lens array 130. Thus, the amount of computation for the image processing may be reduced, the image processing speed may be improved, and the power consumption of the image sensor 1000 may be reduced. In addition, by finely adjusting the positions of pixels in the sensor board 110 and adjusting the distribution of displacement vectors defined in the unit pixel group 110G, aliasing due to down-sampling may be reduced.

Hereinafter, various embodiments that may have such similar effects are shown.

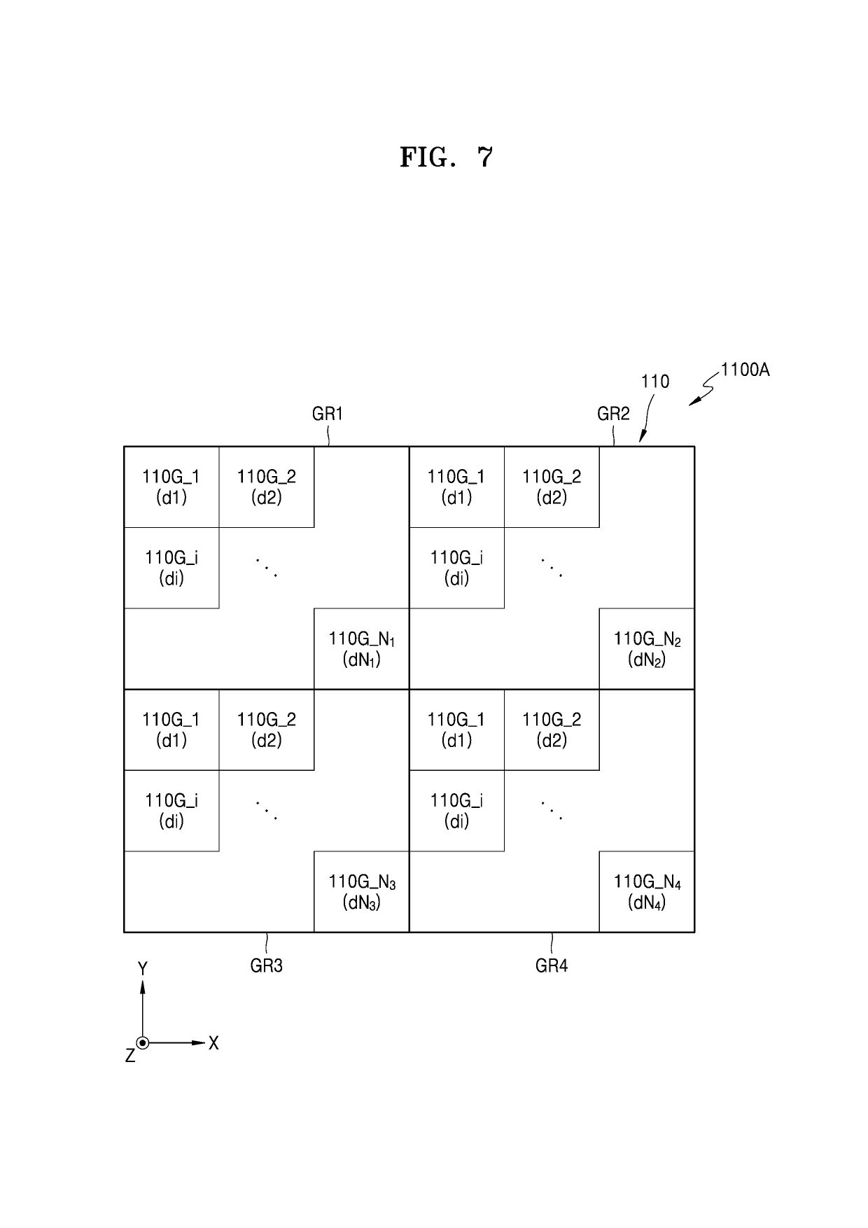

FIG. 7 is a plan view of a sensor board provided in a pixel array of an image sensor, according to another embodiment.

According to an embodiment illustrated in FIG. 7, the image sensor may include a pixel array 1100A, in which, the unit pixel groups 110G of the sensor board 110 of the pixel array 1100A may be grouped into a plurality of groups. For example, FIG. 7 shows four groups GR1, GR2, GR3, and GR4.

The group GR1 may include a unit pixel group 110G_1 having a displacement vector d1, a unit pixel group 110G_2 having a displacement vector d2, a unit pixel group 110G_i having a displacement vector di, and a unit pixel group 110G_N₁ having a displacement vector dN₁.

The group GR2 may include a unit pixel group 110G_1 having a displacement vector d1, a unit pixel group 110G_2 having a displacement vector d2, a unit pixel group 110G_i having a displacement vector di, and a unit pixel group 110G_N₂ having a displacement vector dN₂.

The group GR3 may include a unit pixel group 110G_1 having a displacement vector d1, a unit pixel group 110G_2 having a displacement vector d2, a unit pixel group 110G_i having a displacement vector di, and a unit pixel group 110G_N₃ having a displacement vector dN₃.

The group GR4 may include a unit pixel group 110G_1 having a displacement vector d1, a unit pixel group 110G_2 having a displacement vector d2, a unit pixel group 110G_i having a displacement vector di, and a unit pixel group 110G_N₄ having a displacement vector dN₄.

The number of unit pixel groups 110G included in the plurality of groups GR1, GR2, GR3, and GR4 may be the same, and the distribution of displacement vectors may be the same. However, the disclosure is not limited thereto, and as such, according to another embodiment, in two or more of the plurality of groups GR1, GR2, GR3, and GR4, the distribution of displacement vectors may be different from each other or may be partially the same.

For example, N1, N2, N3, and N4 may be all different, all the same, or two or more thereof may be the same. The distribution of d1 to dN₁, the distribution of d1 to dN₂, the distribution of d1 to dN₃, the distribution of d1 to dN₄ may all be different, all the same, or two or more thereof may be the same.

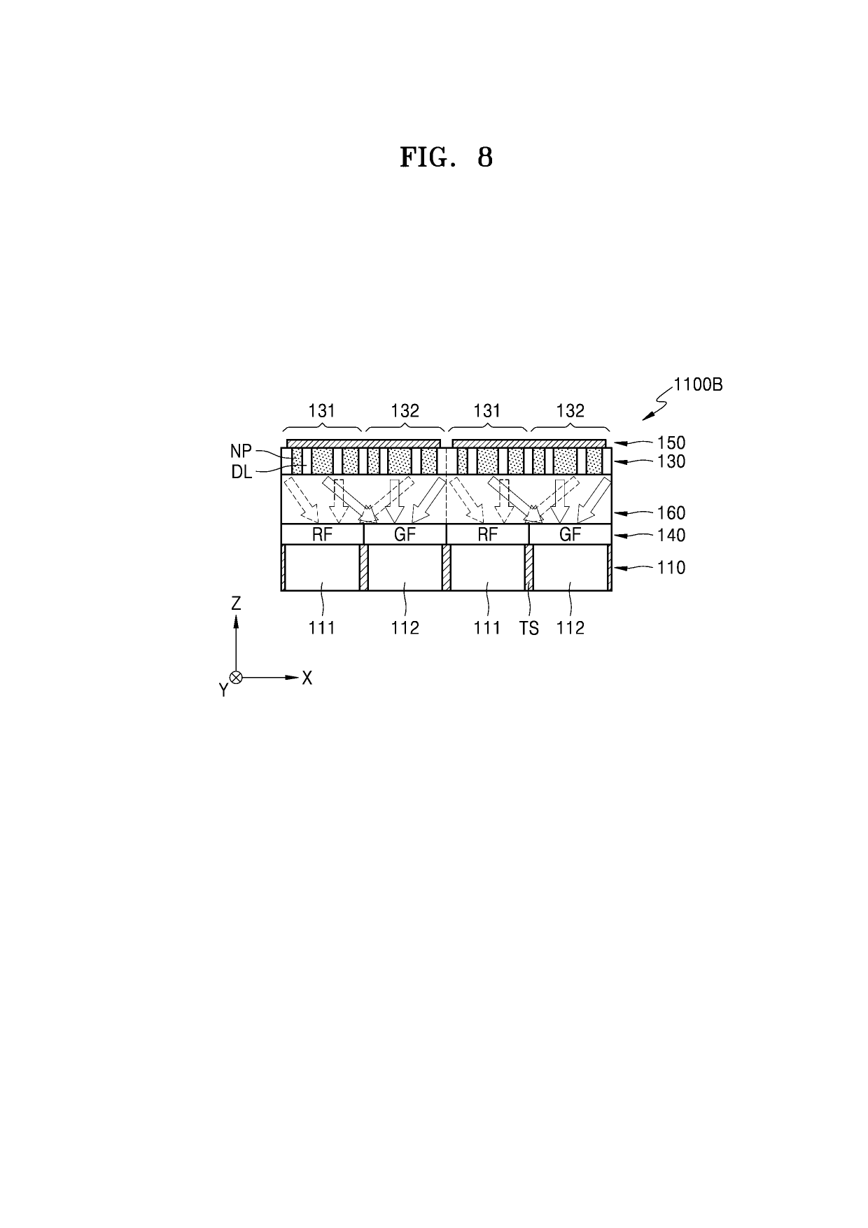

FIG. 8 is a cross-sectional view of a pixel array of an image sensor, according to another embodiment.

According to an embodiment illustrated in FIG. 8, the image sensor may include a pixel array 1100B. Thepixel array 1100B shown in FIG. 3A is different from a pixel array 1100B of FIG. 8 in that the pixel array 1100B further includes an optical diffuser 150 provided on the nano-optical lens array 130.

The optical diffuser 150 may scatter incident light to be incident on the nano-optical lens array 130. As shown above, the optical diffuser 150 may be partitioned into units corresponding to a plurality of unit structures 130G included in the nano-optical lens array 130. The directionality of the incident light may be removed by the optical diffuser 150 and the incident light may be incident on the nano-optical lens array 130. In addition, the optical diffuser 150 may further ensure optical separation between the plurality of unit structures 130G of the nano-optical lens array 130. The light transmitted through the optical diffuser 150 and incident on the nano-optical lens array 130 may be color separated for each wavelength by the nano-optic lens array 130 and focused into each of the first to fourth pixels 111, 112, 113, and 114.

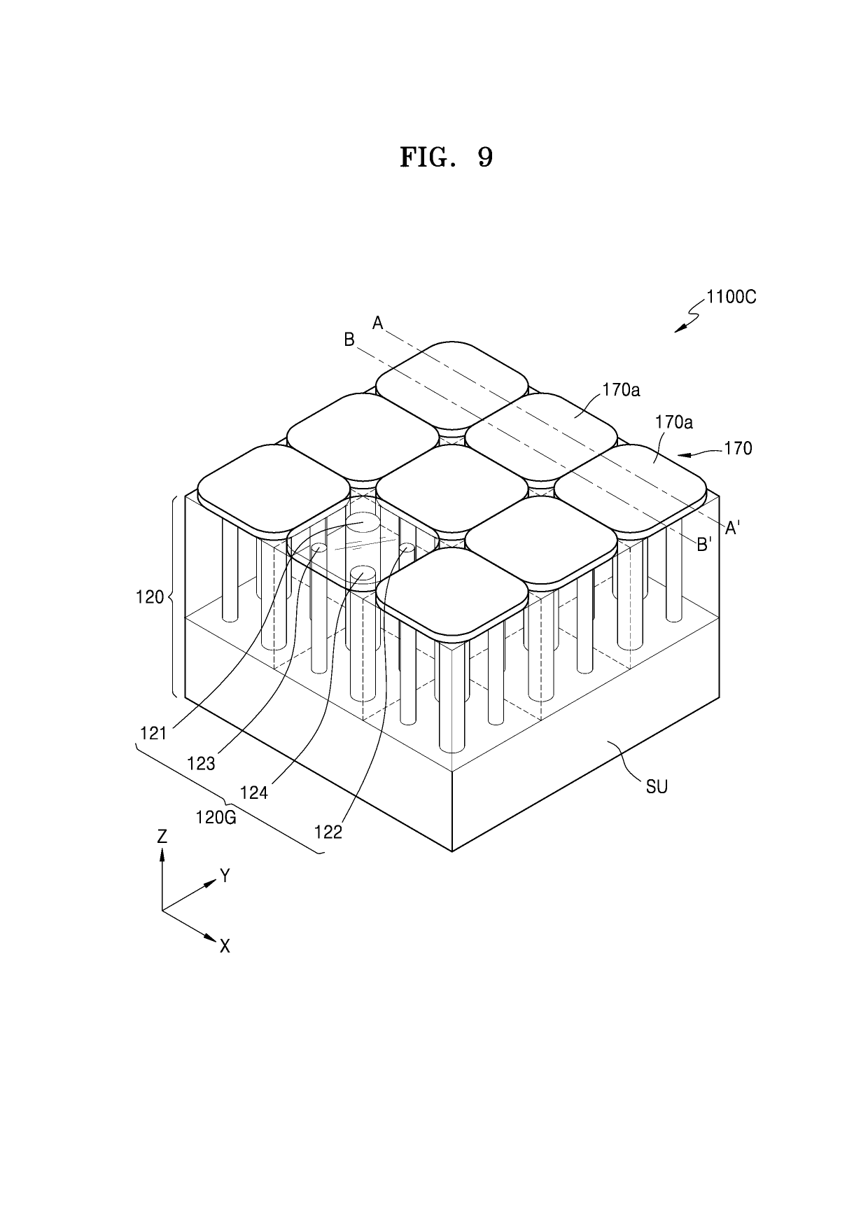

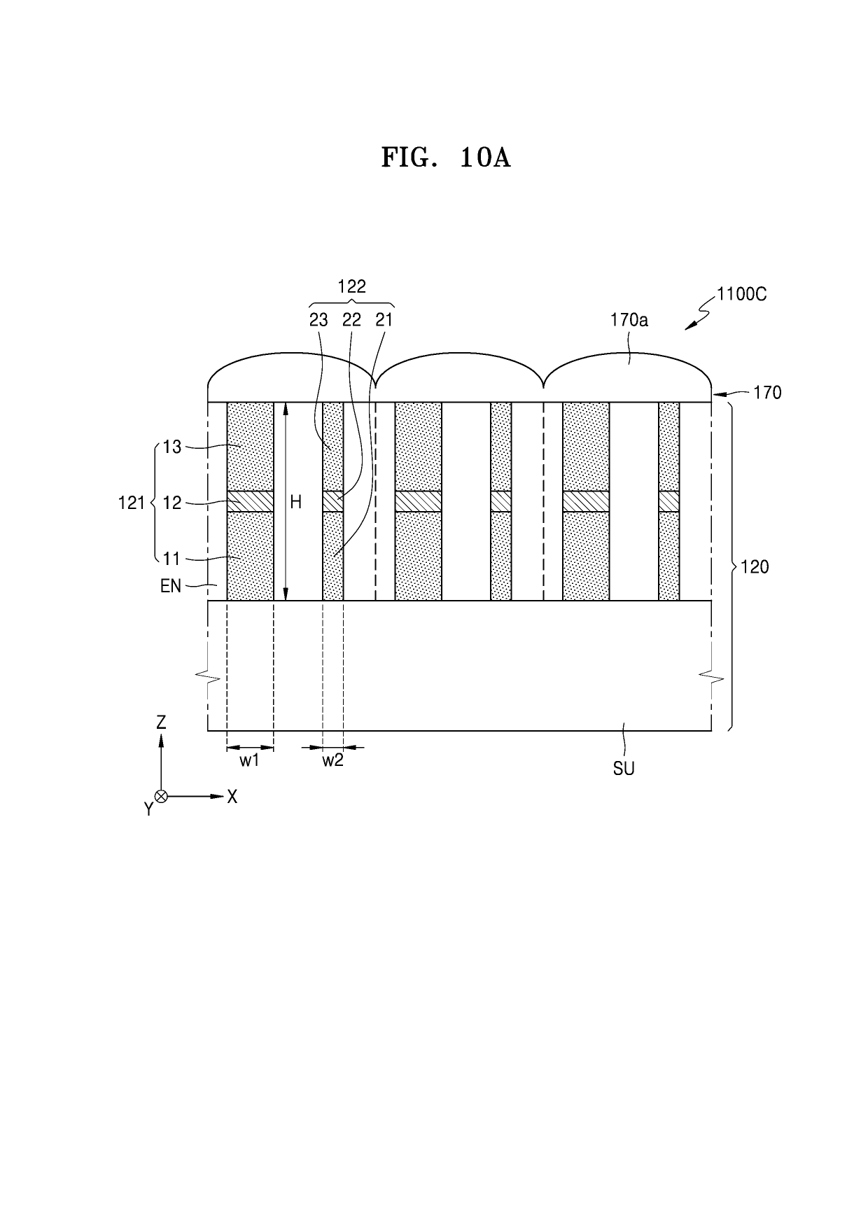

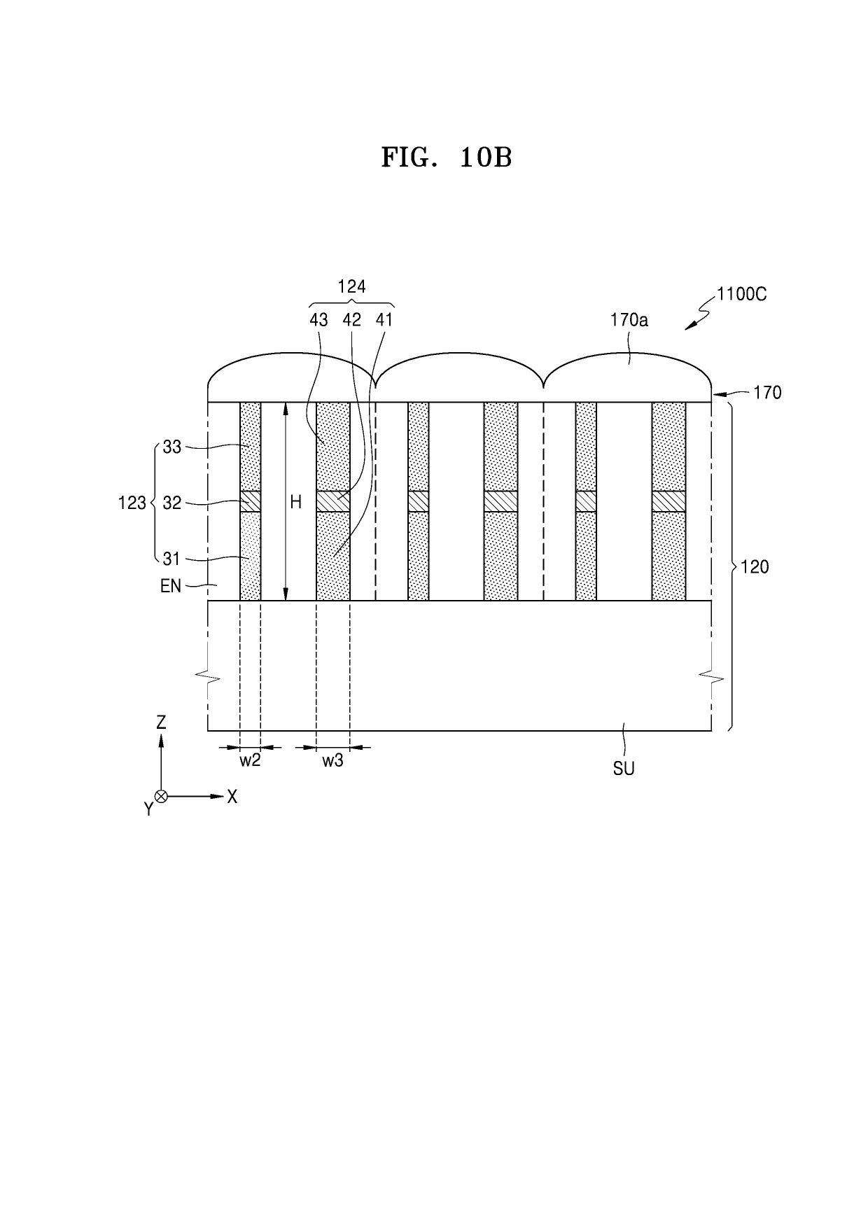

FIG. 9 is a schematic perspective view showing the configuration of a pixel array of an image sensor, according to another embodiment, FIG. 10A is a cross-sectional view taken along line A-A’ in FIG. 9; and FIG. 10B is a cross-sectional view taken along line B-B’ in FIG. 9.

According to an embodiment illustrated in FIG. 9, the image sensor may include a pixel array 1100C. The pixel array 1100C of the image sensor according to an embodiment includes photodiodes for sensing incident light separately for each wavelength.

According to an embodiment, the pixel array 1100C includes a sensor board 120, which includes a plurality of unit pixel groups 120G arranged repeatedly. The plurality of unit pixel groups 120G include a plurality of pixels. The plurality of pixels include a first photodiode 121 that selectively absorbs light of a red wavelength band, second and third photodiodes 122 and 123 that selectively absorb light of a green wavelength band, and a fourth photodiode 124 that selectively absorbs light of a blue wavelength band. The first photodiode 121 may be referred to as a red photodiode, the second and third photodiodes 122 and 123 may be referred to as green photodiodes, and the fourth photodiode 124 may be referred to as a blue photodiode.

Referring to FIGS. 10A and 10B, the first to fourth photodiodes 121, 122, 123, and 124, including rod-shaped vertical photodiodes each having a shape dimension less than the wavelength of incident light, selectively absorb light of a specific wavelength band by waveguide mode-based resonance. The first photodiode 122, the second photodiode 122 and the fourth photodiode 124 may have cross-sectional widths of w1, w2, and w3, respectively, perpendicular to the height direction (Z direction). Two or more widths of w1, w2, and w3 may be different from each other. The widths of w1, w2, and w3 may all be different. The widths of w1, w2, and w3 may range, for example, from about 50 nm to about 200 nm. Each of the widths of w1, w2, and w3 is set so that light of a wavelength satisfying each waveguide mode resonance requirement, from the light incident on the unit pixel group 120G, may be guided inside the corresponding photodiode. For example, among the widths of w1, w2, and w3, the width of w1 may be the largest and w2 may be the smallest. For example, the width of w1 may be about 100 nm and may range from about 95 nm to about 105 nm. The width of w3 may be about 85 nm and may range from about 80 nm to about 90 nm. The width of w2 may be about 60 nm and may range from about 55 nm to about 65 nm. From the incident light, the red light and the blue light may be absorbed by the first photodiode 121 with the width of w1 and the fourth photodiode 124 with the width of w3, respectively. The green light may be absorbed by the second photodiode 122 and the third photodiode 123, each having the width of w2.

The arrangement of the first to fourth photodiodes 121, 122, 123, and 124 within one unit pixel group 120G may be in the form of a square with a line connecting centers of the first to fourth photodiodes 121, 122, 123, and 124. However, this arrangement is only an example.

The height H of the first to fourth photodiodes 121, 122, 123, and 124 may be about 500 nm or more, or 1 μm or more, or 2 μm or more. This height H may be set considering the position at which light incident on the photodiode is absorbed, that is, the depth from the surface of the photodiode. A shorter wavelength of light having higher energy is absorbed closer to the upper surface of the photodiode, and a longer wavelength of light is absorbed at a deeper position of the photodiode. The first to fourth photodiodes 121, 122, 123, and 124 may have the same height as shown. In an example case in which the first to fourth photodiodes 121, 122, 123, and 124 have the same height, the manufacturing process may generally be easy. In this case, the height at which light is sufficiently absorbed may be set based on light in a long wavelength band. However, the height is not limited thereto. The height of the first to fourth photodiodes 121, 122, 123, and 124 and may vary depending on the wavelength of the light to be sensed. An appropriate upper limit may be set, in consideration of quantum efficiency and process difficulty, for each wavelength, and may be, for example, 10 μm or less, or 5 μm or less.

The first to fourth photodiodes 121, 122, 123, and 124 include rod-shaped pin photodiodes. The first photodiode 121 may include a first conductive semiconductor layer 11, an intrinsic semiconductor layer 12, and a second conductive semiconductor layer 13. The second photodiode 122 may include a first conductive semiconductor layer 21, an intrinsic semiconductor layer 22, and a second conductive semiconductor layer 23, and the third photodiode 123 may include a first conductive semiconductor layer 31, an intrinsic semiconductor layer 32, and a second conductive semiconductor layer 33. Since the second photodiode 122 and the third photodiode 123 sense the green light, the second photodiode 122 and the third photodiode 123 may be the same. The fourth photodiode 124 may include a first conductive semiconductor layer 41, an intrinsic semiconductor layer 42, and a second conductive semiconductor layer 43. The first to fourth photodiodes 121, 122, 123, and 124 are shown in a cylindrical shape, but are not limited thereto. For example, the first to fourth photodiodes 121, 122, 123, and 124 may adopt a polygonal cylindrical shape, such as a quadrangular cylindrical shape or a hexagonal cylindrical shape.

The first to fourth photodiodes 121, 122, 123, and 124 may be formed based on a silicon semiconductor. For example, the first conductive semiconductor layers 11, 21, 31, and 41 may include p-Si, the intrinsic semiconductor layers 12, 22, 32, and 42 may include i-Si, and the second conductive semiconductor layers 13, 23, 33, and 43 may include n-Si. The first conductive semiconductor layers 11, 21, 31, and 41 may include n-Si and the second conductive semiconductor layers 13, 23, 33, and 43 may include p-Si. However, the disclosure is not limited thereto.

A surrounding material EN of the first to fourth photodiodes 121, 122, 123, and 124 may include air or may include a material having a refractive index lower than the refractive index of the first to four photodiodes 121, 122, 123, and 124. For example, the surrounding material EN may include, but is not limited to, SiO₂, Si₃N₄, or Al₂O₃.

The sensor board 120 may further include a circuit board SU supporting the first to fourth photodiodes 121, 122, 123, and 124. The circuit board SU may include a circuit element that not only supports the first to fourth photodiodes 121, 122, 123, and 124 but also processes electrical signals generated by absorbing light from the first to fourth photodiodes 121, 122, 123, and 124. For example, an electrode wiring structure for the first to fourth photodiodes 121, 122, 123, and 124 may be provided on the circuit board SU. In addition, various circuit elements required for the image sensor 1000 may be integrated with the circuit board SU. For example, a logic layer including various analog circuits and digital circuits may be provided, and a memory layer in which data is stored may be provided. The logic layer and the memory layer may include different layers or the same layer. Some of the circuit elements illustrated with reference to FIG. 1 may be provided on the circuit board SU.

A microlens array 170 may be further provided on the sensor board 120. The microlens array 170 includes a plurality of microlenses 170a, each of which may face a respective one of the plurality of unit pixel groups 120G.

The pixel array 1100C may also include an optical diffuser. For example, the optical diffuser 150 described with reference to FIG. 8 may be provided, along with the microlens array 170. The configuration of the microlens array 170 or optical diffuser may be changed to other optical elements.

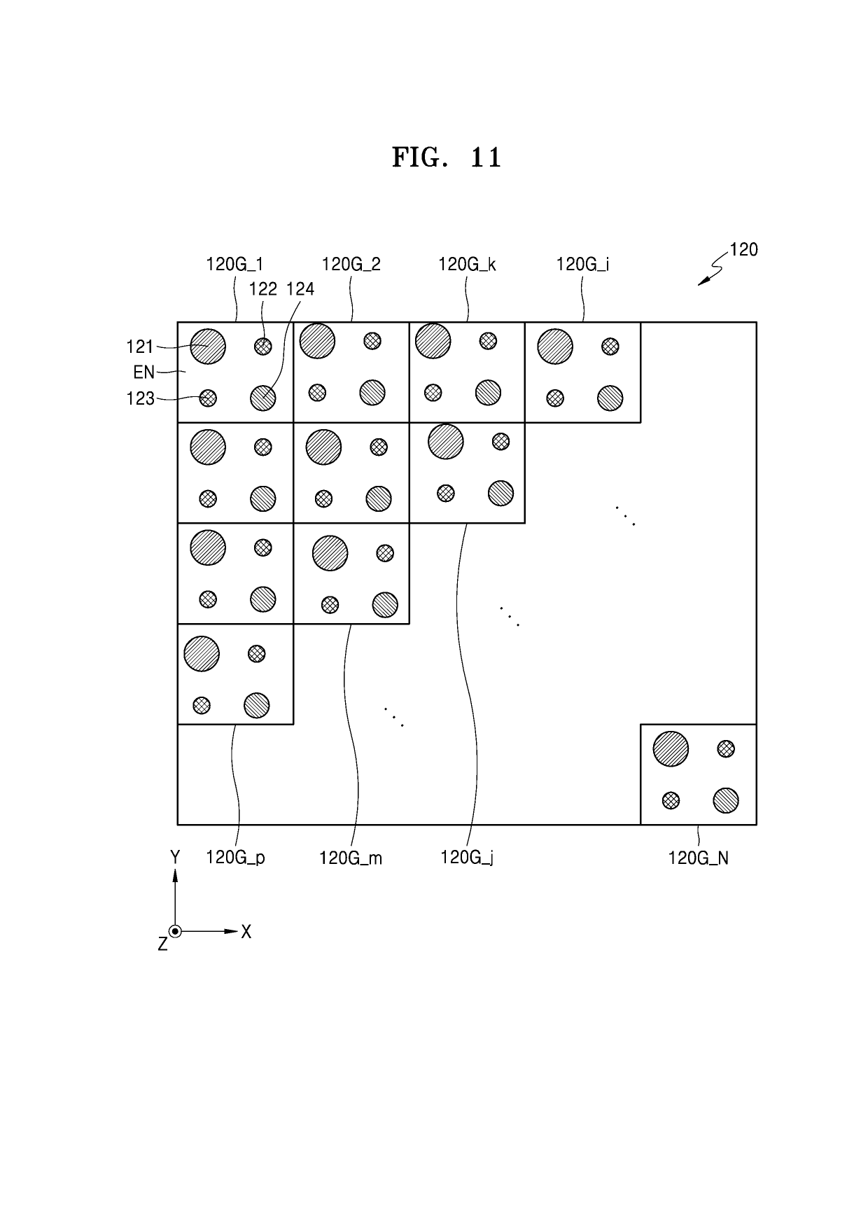

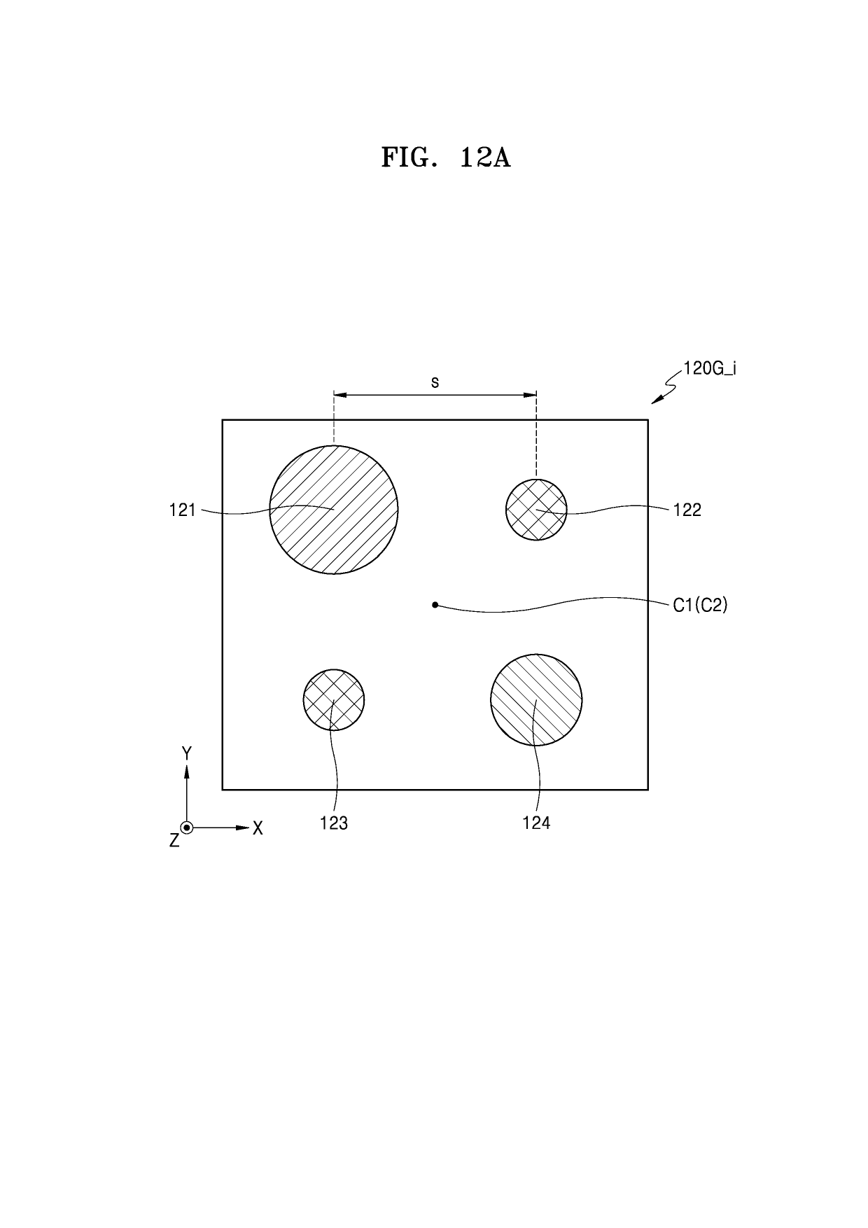

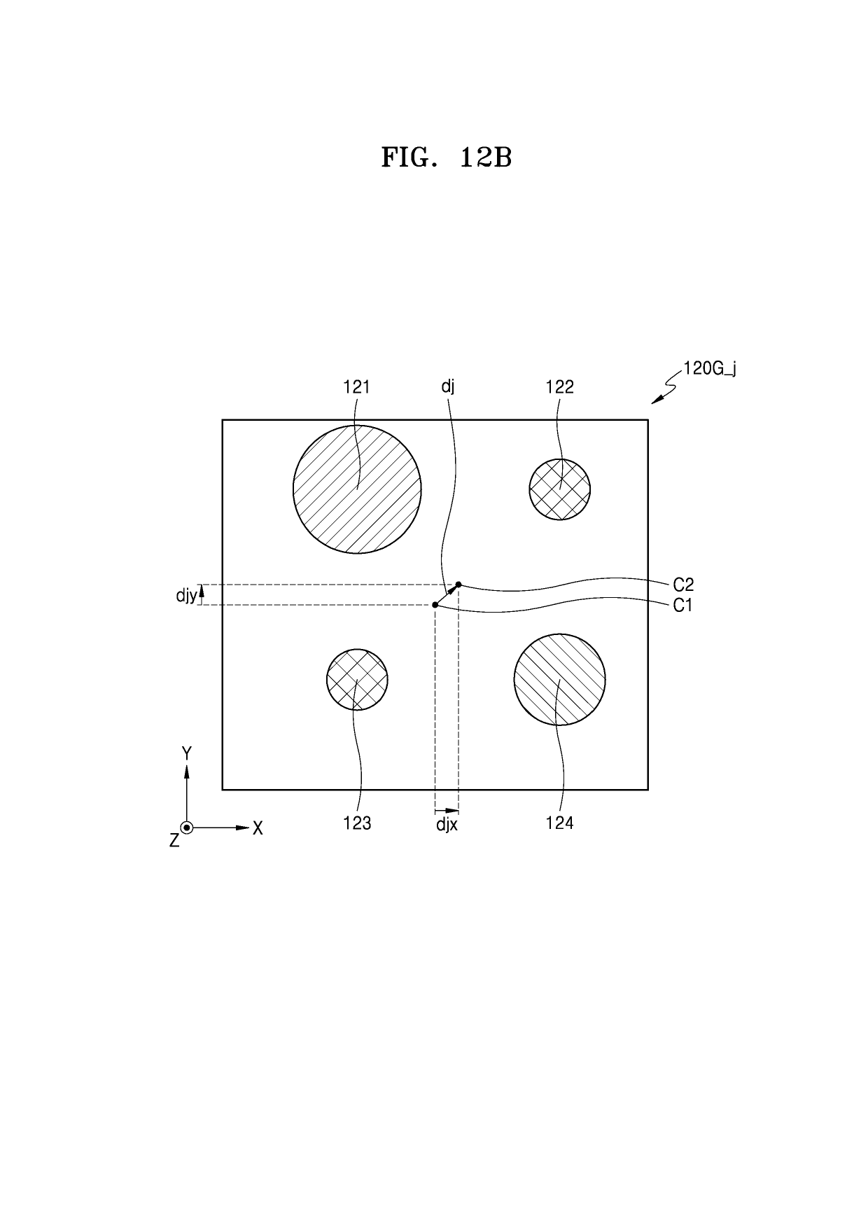

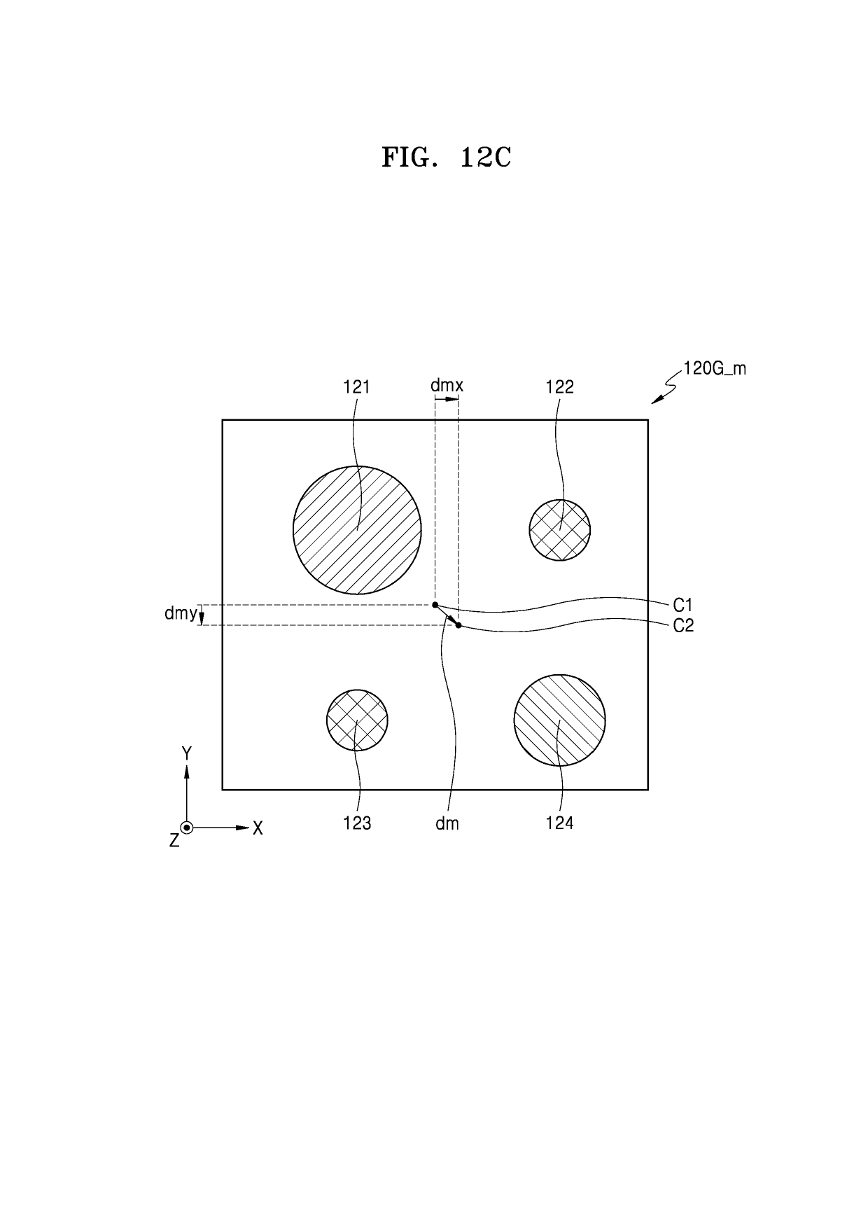

FIG. 11 is a plan view illustrating a pixel arrangement of a sensor board provided in the image sensor in FIG. 9. FIGS. 12A to 12C are plan views showing unit pixel groups and displacement vectors defined therein at different positions of the sensor board in FIG. 11.

In FIG. 11, a plurality of unit pixel groups 120G included in the sensor board 120 are indicated by indexes, such as unit pixel group 120G_i, depending on the positions of the plurality of unit pixel groups 120G.

Depending on the position of the unit pixel group 120G, the relative positions of the first to fourth photodiodes 121, 122, 123, and 124 in the unit pixel group 120G may be different from each other. For example, the positions of the first to fourth photodiodes 121, 122, 123, and 124 in the unit pixel group 120G_i may be different from the positions of the first to fourth photodiodes 122, 112, 123 and 124 in the unit pixel group 120G_j.

In FIGS. 12A to 12C, a first center C1 and a second center C2 are defined in a manner similar to that described with reference to FIGS. 5A to 5E. The first center C1 is the center of the unit pixel group 120G and the second center C2 is the center of the array of the first to fourth photodiodes 121, 122, 123, and 124 included in the unit pixel group 120G. The first center C1 may be described as a position within the unit pixel group 120G, facing the center of a microlens 170a of the microlens array 170. The first to fourth photodiodes 121, 122, 123, and 124 may be arranged to be spaced apart from the first center C1, by a certain displacement, and the first to fourth photodiodes 121, 122, 123, and 124 in one unit pixel group 120G are spaced apart from the first center C1 by the same displacement. Thus, a displacement vector in the unit pixel group 120G may be defined as the vector from the first center C1 to the second center C2.

Referring to FIG. 12A, the displacement vector in the unit pixel group 120G_i is 0, that is, the first center C1 and the second center C2 coincide.

Referring to FIG. 12B, in the unit pixel group 120G_j, the displacement vector dj has an X-direction component of djx and a Y-direction component of djy.

Referring to FIG. 12C, in the unit pixel group 110G_m, the displacement vector dm has an X-direction component of dmx and a Y-direction component of −dmy.

The displacement vectors described with reference to FIGS. 12A to 12C are only examples. The displacement vectors in the plurality of unit pixel groups 120G in the sensor board 120 may have an irregular distribution in a size range of less than or equal to the maximum displacement. The maximum displacement includes the distance between the centers of adjacent pixels. The maximum displacement may be, for example, the distance s between the centers of the first photodiode 121 and the second photodiode 122. The maximum displacement may be s/√2. The direction of the displacement vector may also be radially random.

Similar to the description with reference to FIGS. 6A and 6B, the x component of the displacement vector, dx, and the y component of the displacement vector, dy, may be equal to or greater than -s/2 and equal to or less than s/2. The dx and dy defined in each of the plurality of unit pixel groups 120G may have a Gaussian distribution in a range of -s/2 or more and s/2 or less. Additionally, dx and dy may have various types of random distributions within the above range.

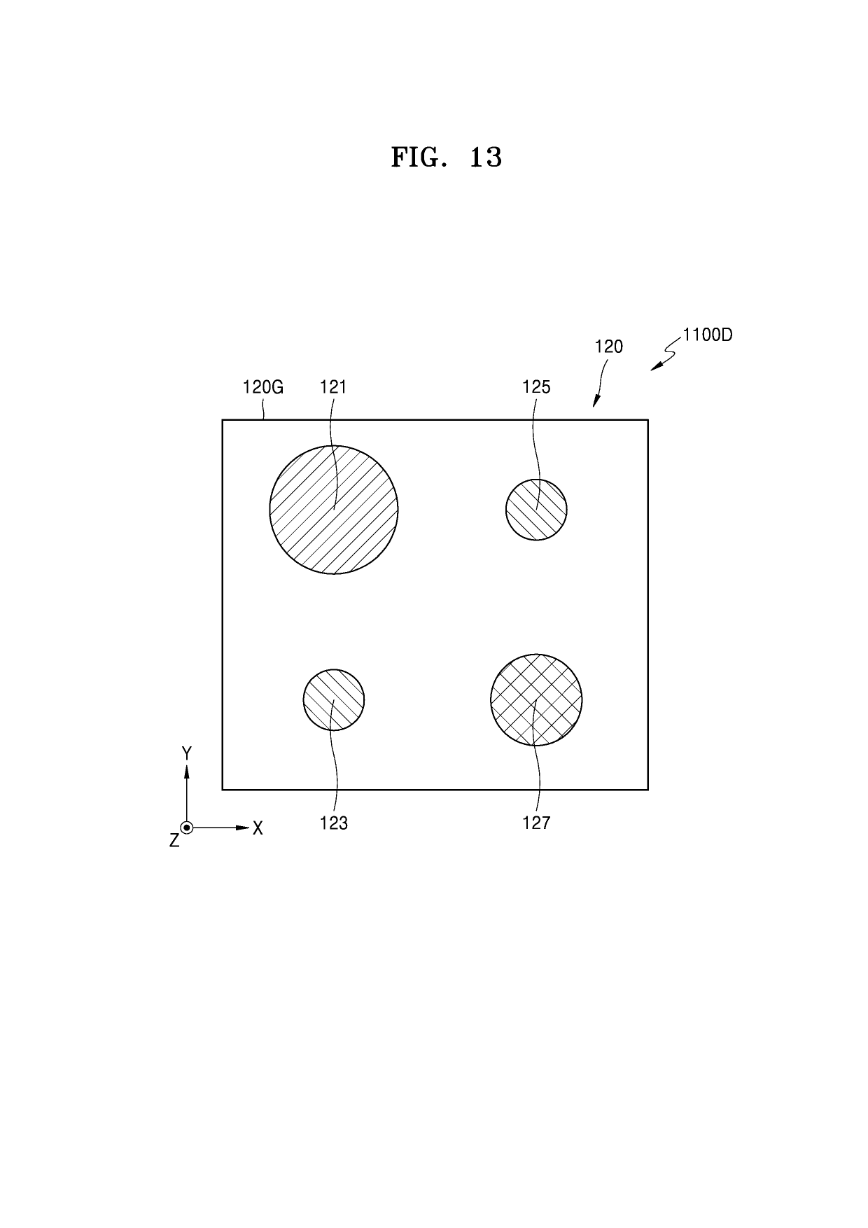

FIG. 13 is a plan view showing a unit pixel group of a sensor board provided in a pixel array of an image sensor, according to another embodiment.

According to an embodiment, a sensor board 120 of a pixel array 1100D of the image sensor of an embodiment differs from that of the pixel array 1100C described with reference to FIG. 9 in that one unit pixel group 120G includes one red photodiode 121, two blue photodiodes 125 and 126, and one green photodiode 127. The other configurations may be substantially similar thereto.

The image sensor, described with reference to FIGS. 9 to 13, provided with photodiodes having different cross-sectional sizes for each color of light to be sensed may have various arrangements other than the arrangement of photodiodes illustrated with reference to FIG. 11. For example, similar to what is described with reference to FIG. 7, the unit pixel group 120G is grouped into various numbers of groups, and the photodiodes may be arranged so that each group has the same or different displacement vector distribution.

The image sensor 1000 according to an embodiment may constitute a camera module with various performance module lenses and may be utilized in various electronic devices.

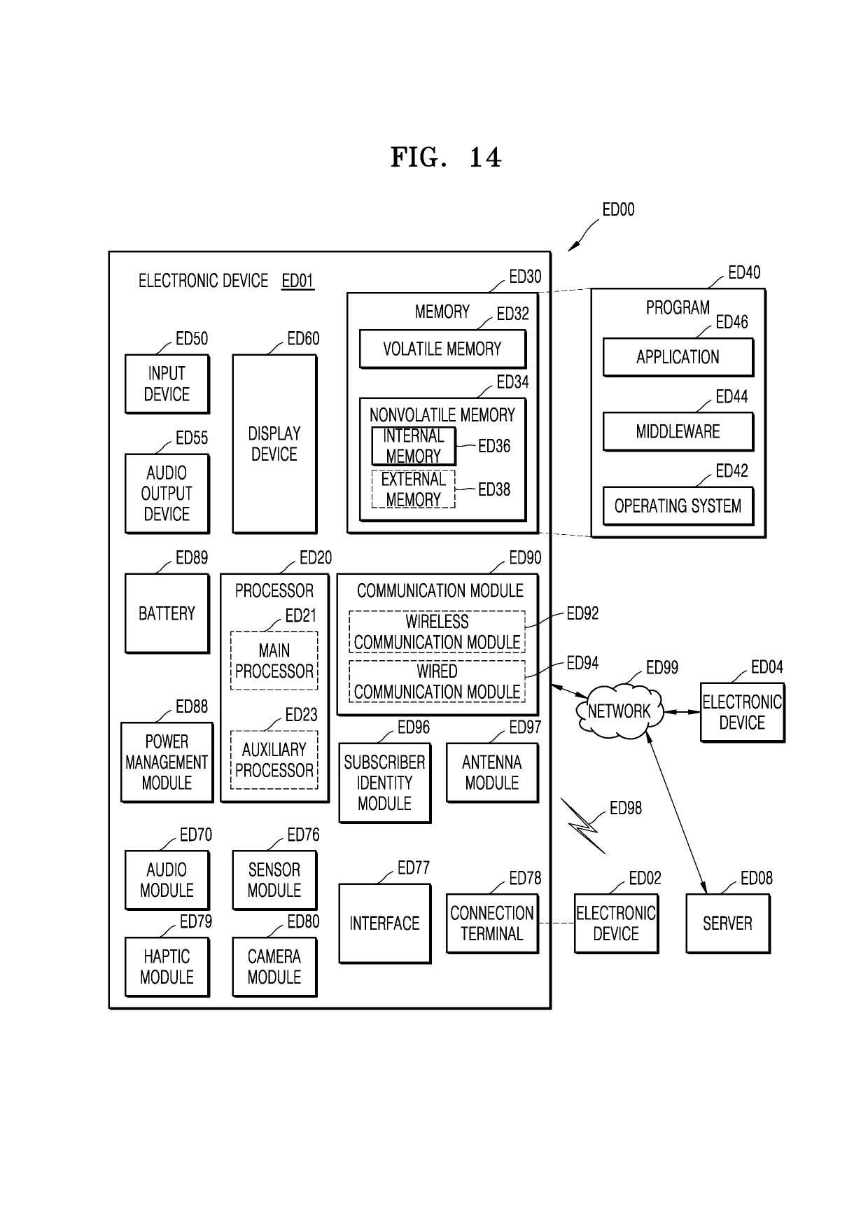

FIG. 14 is a schematic block diagram of an electronic device ED01 including an image sensor 1000, according to an embodiment. Referring to FIG. 14, in a network environment ED00, the electronic device ED01 may communicate with another electronic device ED02 through a first network ED98 (e.g., a short-range wireless communication network) or may communicate with another electromagnetic device ED04 and/or a server ED08 through a second network ED99 (e.g., a long-range wireless communication network). The electronic device ED01 may communicate with the electronic device ED04 through the server ED08. The electronic device ED01 may include a processor ED20, memory ED30, an input device ED50, an audio output device ED55, a display device ED60, an audio module ED70, a sensor module ED76, an interface ED77, a haptic module ED79, a camera module ED80, a power management module ED88, a battery ED89, a communication module ED90, a subscriber identity module ED96, and/or an antenna module ED97. In the electronic device ED01, some of these components (e.g., the display device ED60) may be omitted or other components may be added. Some of these components may be implemented as one integrated circuit. For example, the sensor module ED76 (e.g., a fingerprint sensor, an iris sensor, or an illuminance sensor) may be embedded in the display device ED60 (e.g., a display).

The processor ED20 may control one or more other components (e.g., hardware or software components) of the electronic device ED01 connected to the processor ED20 by executing software (e.g., program ED40), and may perform various data processing or computation. As part of data processing or computation, the processor ED20 may load commands and/or data received from other components (e.g., sensor module ED76 or communication module ED90) into volatile memory ED32, process the commands and/or data stored in the volatile memory ED32, and store the resulting data in nonvolatile memory ED34. The processor ED20 may include a main processor ED21 (e.g., a central processing unit or an application processor) and an auxiliary processor ED23 (e.g., a graphics processing unit, an image signal processor, a sensor hub processor, or a communication processor), which operate independently or jointly. The auxiliary processor ED23 may use less power than the main processor ED21 and may perform a specialized function.

The auxiliary processor ED23 may control functions and/or states related to some of the components of the electronic device ED01 (e.g., the display device ED60, the sensor module ED76, or the communication module ED90), instead of the main processor ED21 while the main processor ED21 is in an inactive state (a sleep state), or together with the main processor ED21 while the main processor ED21 is in an active state (e.g., a state in which an application is executed). The auxiliary processor ED23 (e.g., the image signal processor or the communication processor) may be implemented as part of another functionally related component (the camera module ED80 or the communication module ED90).

The memory ED30 may store various data required by a component of the electronic device ED01 (e.g., the processor ED20 or the sensor module ED76). The data may include, for example, input data and/or output data for software (e.g., program ED40) and commands associated therewith. The memory ED30 may include the volatile memory ED32 and/or the nonvolatile memory ED34.

The program ED40 may be stored as software in the memory ED30 and may include an operating system ED42, a middleware ED44, and/or an application ED46.

The input device ED50 may receive the commands and/or data to be used for a component (e.g., the processor ED20) of the electronic device ED01 from the outside (e.g., a user). The input device ED50 may include a microphone, a mouse, a keyboard, and/or a digital pen (e.g., a stylus pen).

The audio output device ED55 may output an acoustic signal to the outside of the electronic device ED01. The audio output device ED55 may include a speaker and/or a receiver. The speaker may be used for general purposes, such as multimedia playback or recorded playback, and the receiver may be used to receive an incoming call. The receiver may be coupled to the speaker as part of the speaker or may be implemented as a separate independent device.

The display device ED60 may visually provide information to the outside of the electronic device ED01. The display device ED60 may include a display, a hologram device, or a projector, and may control circuitry for controlling the same. The display device ED60 may include touch circuitry configured to sense a touch, and/or sensor circuitry (e.g., a pressure sensor) configured to measure an intensity of a force generated by the touch.

The audio module ED70 may convert sound into an electrical signal, or vice versa. The audio module ED70 may acquire a sound through the input device ED50 or output a sound through the audio output device ED55 and/or a speaker and/or a headphone of another electronic device (e.g., the electronic device ED02) directly or wirelessly connected to the electronic device ED01.

The sensor module ED76 may sense an operating state (e.g., power or temperature) of the electronic device ED01 or an external environment state (e.g., user state) and may generate an electrical signal and/or a data value corresponding to the sensed state. The sensor module ED76 may include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface ED77 may support one or more specified protocols which can be used for the electronic device ED01 to connect directly or wirelessly with another electronic device (e.g., the electronic device ED02). The interface ED77 may include a high-definition multimedia interface (HDMI), a universal serial bus (USB) interface, a secure digital (SD) card interface, and/or an audio interface.

A connection terminal ED78 may include a connector through which the electronic device ED01 can be physically connected to another electronic device (e.g., the electronic device ED02). The connection terminal ED78 may include an HDMI connector, a USB connector, an SD card connector, and/or an audio connector (e.g., a headphone connector).

The haptic module ED79 may convert an electrical signal into a mechanical stimulus (e.g., vibration or movement) or an electrical stimulus which can be perceived by the user through tactile or kinesthetic senses. The haptic module ED79 may include a motor, a piezoelectric element, and/or an electrical stimulation device.

The camera module ED80 may capture a still image and a moving image. The camera module ED80 may include a lens assembly including one or more lenses, the image sensor 1000 of FIG. 1, image signal processors, and/or flashes. The lens assembly included in the camera module ED80 may transmit light emitted from a subject to be imaged.

The power management module ED88 may manage the power supplied to the electronic device ED01. The power management module ED88 may be implemented as part of a power management integrated circuit (PMIC).

The battery ED89 may supply power to the components of the electronic device ED01. The battery ED89 may include a non-rechargeable primary battery, a rechargeable secondary battery, and/or a fuel cell.

The communication module ED90 may support establishment of a direct (wired) communication channel and/or a wireless communication channel between the electronic device ED01 and another electronic device (e.g., the electronic device ED02, the electronic device ED04, or the server ED08), and communication through the established communication channels. The communication module ED90 may include one or more communication processors that operate independently of the processor ED20 (e.g., an application processor) and support direct communication and/or wireless communication. The communication module ED90 may include a wireless communication module ED92 (e.g., a cellular communication module, a short-range communication module, or a global navigation satellite system (GNSS) communication module) and/or a wired communication module ED94 (e.g., a local area network (LAN) communication module or a power line communication module). The corresponding communication module, among these communication modules, may communicate with another electronic device through the first network ED98 (e.g., a short-range communication network, such as Bluetooth, WiFi Direct, or infrared data association (IrDA)) or the second network ED99 (e.g., a long-range communication network, such as a cellular network, the Internet, or a computer network (LAN or wide area network (WAN))). These various types of communication modules may be integrated into one component (e.g., a single chip) or may be implemented into a plurality of components (a plurality of chips) separate from each other. The wireless communication module ED92 may confirm and authenticate the electronic device ED01 in a communication network, such as the first network ED98 and/or the second network ED99, by using subscriber information (e.g., an international mobile subscriber identifier (IMSI)) stored in the subscriber identity module ED96.

The antenna module ED97 may transmit or receive signals and/or power to or from the outside (e.g., another electronic device). The antenna module ED97 may include a radiator of a conductive pattern formed on a substrate (e.g., a printed circuit board (PCB)). The antenna module ED97 may include one or more antennas. In an example case in which the antenna module ED97 includes a plurality of antennas, an antenna suitable for a communication method used in a communication network, such as the first network ED98 and/or the second network ED99, may be selected from among the plurality of antennas by the communication module ED90. The signals and/or power may be transmitted or received to and from the communication module ED90 and another electronic device via the selected antenna. In addition to the antennas, another component (e.g., a radio-frequency integrated circuit (RFIC)) may be included in the antenna module ED97 as a part of the antenna module ED97.

Some of the components may be connected to each other through a communication method (e.g., bus, general purpose input and output (GPIO), serial peripheral interface (SPI), or mobile industry processor interface (MIPI)) between peripheral devices, and may exchange signals (e.g., commands or data).

The commands or data may be exchanged between the electronic device ED01 and the external electronic device ED04 through the server ED08 connected to the second network ED99. The other electronic devices ED02 and ED04 may be the same or different types of devices as the electronic device ED01. All or some of the operations executed by the electronic device ED01 may be executed by one or more of the other electronic devices ED02, ED04, and ED08. In an example case in which the electronic device ED01 needs to perform certain functions or services, the electronic device ED01 may request one or more other electronic devices to perform some or all of the functions or services, instead of executing the functions or services on its own. The one or more other electronic devices that have received the request may execute additional functions or services associated with the request and communicate the result of the execution to the electronic device ED01. To this end, cloud computing, distributed computing, and/or client-server computing technologies may be utilized.

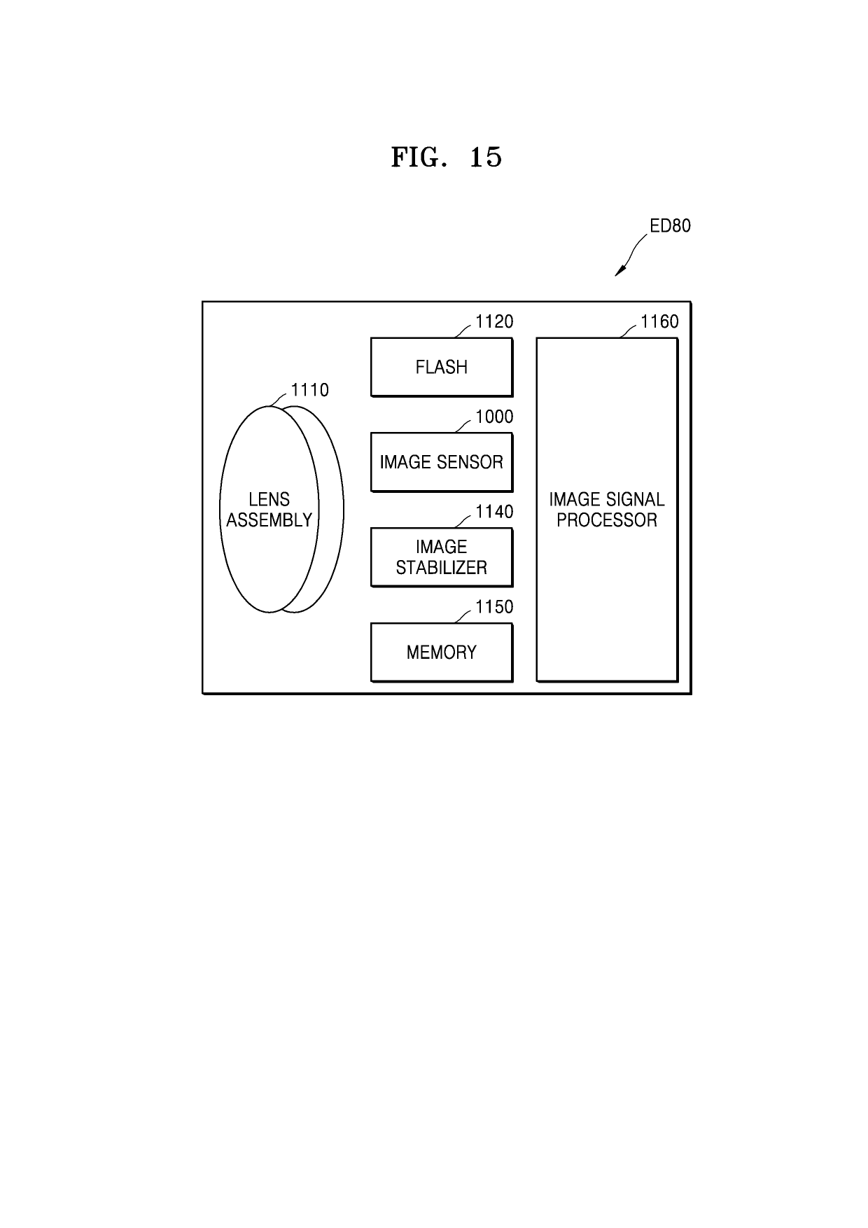

FIG. 15 is a schematic block diagram of a camera module ED80 included in the electronic device ED01 in FIG. 14. Referring to FIG. 15, the camera module ED80 may include a lens assembly 1110, a flash 1120, an image sensor 1000, an image stabilizer 1140, memory 1150 (e.g., buffer memory), and/or an image signal processor 1160. The lens assembly 1110 may transmit light emitted from a subject to be imaged. The camera module ED80 may include a plurality of lens assemblies 1110. In this case, the camera module ED 80 may include a dual camera, a 360-degree camera, or a spherical camera. Some of the plurality of lens assemblies 1110 may have the same lens properties (e.g., angle of view, focal length, autofocus, F number, or optical zoom) or may have different lens properties. The lens assemblies 1110 may include a wide-angle lens or a telephoto lens.

The flash 1120 may emit light used to enhance light emitted or reflected from a subject. The flash 1120 may emit visible or infrared light. The flash 1120 may include one or more light-emitting diodes (e.g., red-green-blue (RGB) LED, white LED, infrared LED, or ultraviolet LED), and/or a xenon lamp. The image sensor 1000 may include the image sensor described with reference to FIG. 1. The image sensor 1000 may acquire an image corresponding to the subject by converting light emitted or reflected from the subject and transmitted through the lens assembly 1110 into the electrical signal.

According to an embodiment, based on (or in response to) the movement of the camera module ED80 or an electronic device including the same, the image stabilizer 1140 may move one or more lenses included in the lens assembly 1110 or the image sensor 1000 in a specific direction or may control the operation characteristics of the image sensor 1000 (e.g., adjusting a read-out timing) to compensate for the negative influence of the movement. The image stabilizer 1140 may detect the movement of the camera module ED80 or the electronic device ED01 by using a gyro sensor or an acceleration sensor, which is arranged inside or outside the camera module ED80. The image stabilizer 1140 may be implemented optically.

The memory 1150 may store part or all of the data of the image acquired through the image sensor 1000 for the next image processing operations. In an example case in which a plurality of images are obtained at high speed, the obtained original data (e.g., Bayer-patterned data or high-resolution data) may be stored in the memory 1150, and then used to transmit the original data of the selected image (e.g., user selection) to the image signal processor 1160. The memory 1150 may be integrated into the memory ED30 of the electronic device ED01 or may be configured as a separate memory that operates independently.

The image signal processor 1160 may obtain an image by using the electrical signals output from the image sensor 1000. In addition, image data of a specific format may be requested from the image sensor 1000 according to the format of the image data required.

In addition, the image signal processor 1160 may perform additional image processing on the image obtained through the image sensor 1000 or the image data stored in the memory 1150. The image processing may include depth map generation, three-dimensional modeling, panorama generation, feature point extraction, image synthesis, and/or image compensation (e.g., noise reduction, resolution adjustment, brightness adjustment, blurring, sharpening, or softening). The image signal processor 1160 may control (e.g., exposure time control or readout timing control) components (e.g., the image sensor 1000) of the camera module ED80.

The image processed by the image signal processor 1160 may be stored again in the memory 1150 for further processing or may be provided to an external component (e.g., the memory ED30, the display device ED60, the electronic device ED02, the electronic device ED04, or the server ED08) of the camera module ED80. The image signal processor 1160 may be integrated into the processor ED20 or may be configured as a separate processor that operates independently of the processor ED20. In an example case in which the image signal processor 1160 is configured as a separate processor from the processor ED20, the image processed by the image signal processor 1160 may be displayed through the display device ED60 after further image processing by the processor ED20.

In addition, the image signal processor 1160 may independently receive two output signals from adjacent light sensing cells in each pixel or sub-pixel of the image sensor 1000 and may generate an autofocus signal from a difference between the two output signals. The image signal processor 1160 may control the lens assembly 1110 based on the autofocus signal such that the focus of the lens assembly 1110 accurately fits the surface of the image sensor 1000.

The electronic device ED01 may further include one or more additional camera modules each having different properties or functions. The camera module may also include a configuration similar to that of the camera module ED80 in FIG. 15. The image sensor provided in the camera module may be implemented as a CCD sensor and/or a CMOS sensor. The image sensor may include one or more sensors selected from image sensors with different properties, such as an RGB sensor, a black and white (BW) sensor, an IR sensor, or an ultraviolet (UV) sensor. In this case, one of the plurality of camera modules ED80 may include a wide-angle camera, and another one thereof may include a telephoto camera. Similarly, one of the plurality of camera modules ED80 may include a front-facing camera, and another one thereof may include a rear-facing camera.

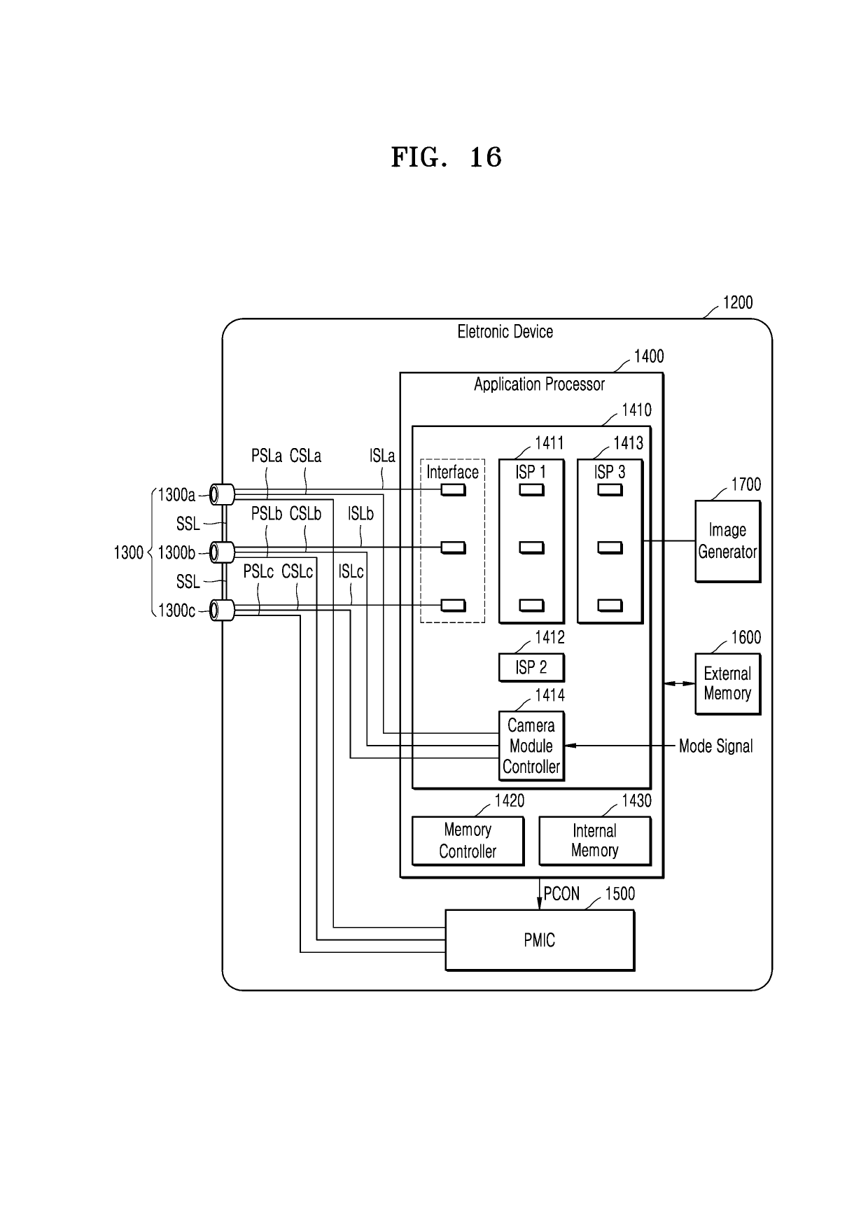

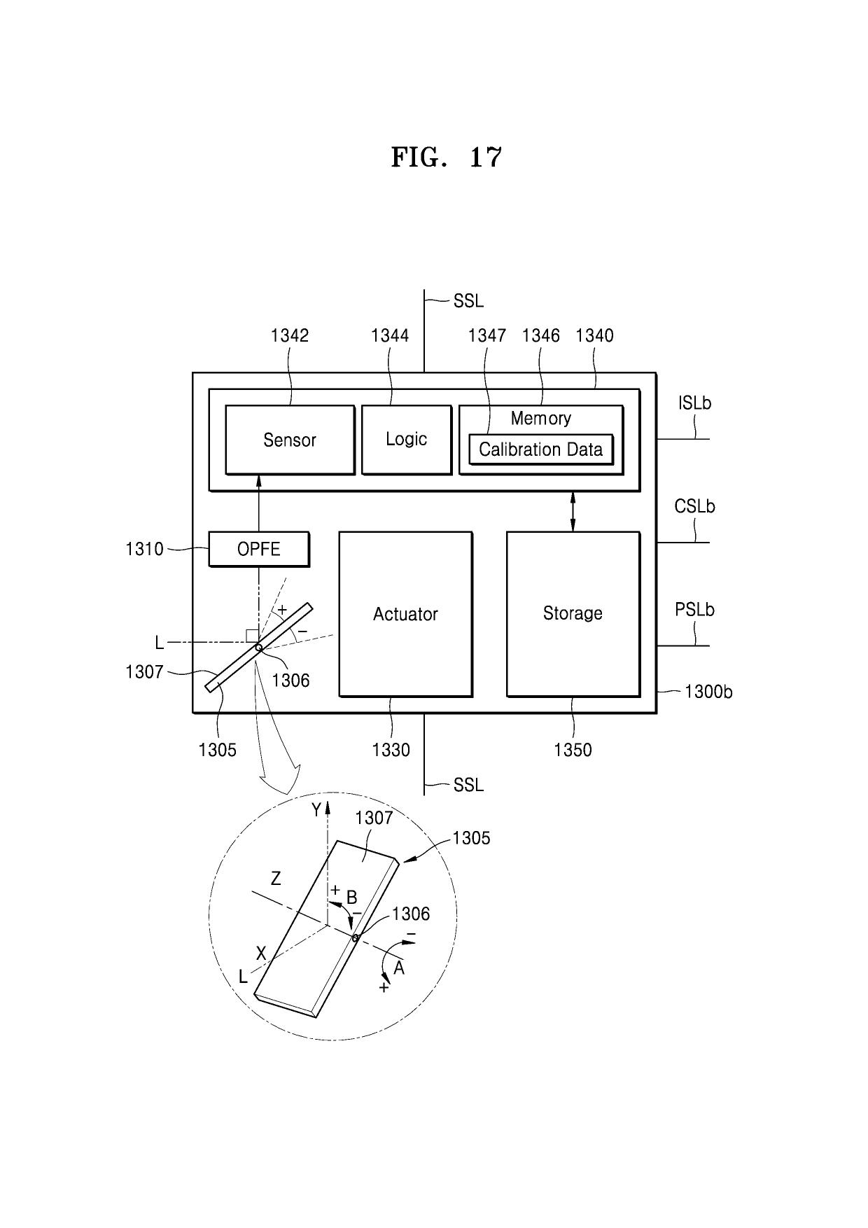

FIG. 16 is a block diagram of an electronic device including a multi-camera module, and FIG. 17 is a detailed block diagram of one camera module included in the electronic device of FIG. 16.

Referring to FIG. 16, an electronic device 1200 may include a camera module group 1300, an application processor 1400, a power management integrated circuit (PMIC) 1500, external memory 1600, and an image generator 1700.

The camera module group 1300 may include a plurality of camera modules 1300a, 1300b, and 1300c. Although FIG. 16 shows an embodiment in which three camera modules 1300a, 1300b, and 1300c are arranged, embodiments are not limited thereto. In some embodiments, the camera module group 1300 may be modified and implemented to include only two camera modules. In addition, in some embodiments, the camera module group 1300 may be modified and implemented to include n (n is a natural number of 4 or more) camera modules.

Hereinafter, the detailed configuration of the camera module 1300b may be described in more detail with reference to FIG. 17. However, the following description may be equally applied to other camera modules 1300a and 1300c, according to an embodiment.

Referring to FIG. 17, the camera module 1300b may include a prism 1305, an optical path folding element (OPFE) 1310, an actuator 1330, an image sensing device 1340, and storage 1350.

The prism 1305 may include a reflective surface 1307 of the light reflective material to modify the path of light L incident from the outside.

In some embodiments, the prism 1305 may change the path of light L incident in the first direction X to the second direction Y perpendicular to the first direction X. In addition, the prism 1305 may rotate the reflective surface 1307 of the light reflective material about the central axis 1306 in the A direction or rotate the central axis 1306 in the B direction to change the path of the light L incident in the first direction X to the second direction Y perpendicular to the first direction X. The OPFE 1310 may also move in a third direction (Z direction) perpendicular to the first direction (X direction) and the second direction (Y direction).

In some embodiments, as shown, the maximum rotation angle of the prism 1305 in the A direction may be 15 degrees or less in the plus (+) A direction and greater than 15 degrees in the minus (−) A direction. However, embodiments are not limited thereto.

In some embodiments, the prism 1305 may be moved in the plus (+) or minus (−) B direction by about 20 degrees, or between about 10 degrees and about 20 degrees, or between about 15 degrees and about 20 degrees, where the angle of movement may be the same angle in the plus (+) or minus (−) B direction or almost similar angle in the range of about 1 degree.

In some embodiments, the prism 1305 may move the reflective surface 1307 of the light reflective material in the third direction (e.g., Z direction) parallel to the extension direction of the central axis 1306.

The OPFE 1310 may include, for example, an optical lens including m (where m is a natural number) groups. The m lenses may move in the second direction (Y direction) to change the optical zoom ratio of the camera module 1300b. In an example case in which the basic optical zoom ratio of the camera module 1300b is referred to as Z and the m optical lenses included in the OPFE 1310 are moved, the optical zoom ratio in the camera module 1300b may be changed to an optical zoom ratio greater than or equal to 3Z or 5Z or 10Z.

The actuator 1330 may move the OPFE 1310 or an optical lens (hereinafter referred to as an optical lens) to a specific position. For example, the actuator 1330 may adjust the position of the optical lens to locate an image sensor 1342 at a focal length of the optical lens for accurate sensing.

The image sensing device 1340 may include the image sensor 1342, control logic 1344, and memory 1346. The image sensor 1342 may sense an image of a sensing target by using light L provided through an optical lens. The control logic 1344 may control the overall operation of the camera module 1300b. For example, the control logic 1344 may control the operation of the camera module 1300b according to a control signal provided through a control signal line CSLb.

The memory 1346 may store information necessary for the operation of the camera module 1300b, such as calibration data 1347. The calibration data 1347 may include information necessary for generating image data using the light L provided from the outside through the camera module 1300b. The calibration data 1347 may include, for example, information about a degree of rotation described above, information about a focal length, and information about an optical axis. In an example case in which the camera module 1300b is implemented in the form of a multi-state camera in which the focal length varies according to the position of the optical lens, the calibration data 1347 may include a focal length value for each position (or each state) of the optical lens and information related to auto focusing.

The storage 1350 may store image data sensed through the image sensor 1342. The storage 1350 may be arranged outside the image sensing device 1340 and may be implemented in a stacked form with a sensor chip constituting the image sensing device 1340. In some embodiments, the storage 1350 may be implemented as electrically erasable programmable read-only memory (EEPROM), although embodiments are not limited thereto.

Referring to FIGS. 16 and 17 together, in some embodiments, each of the plurality of camera modules 1300a, 1300b, and 1300c may include an actuator 1330. Accordingly, each of the plurality of camera modules 1300a, 1300b, and 1300c may include the same or different calibration data 1347 according to the operation of the actuator 1330 included therein.

In some embodiments, one camera module (e.g., 1300b) of the plurality of camera modules 1300a, 1300b, and 1300c may include a folded lens-type camera module including the prism 1305 and the OPFE 1310 described above. The other camera modules (e.g., 1300a and 1300b) may include a vertical-type camera module including neither the prism 1305 nor the OPFE 1310. However, embodiments are not limited thereto.

In some embodiments, one camera module (e.g., 1300c) of the plurality of camera modules 1300a, 1300b, and 1300c may include a vertical-type depth camera that extracts depth information using, e.g., an infrared ray (IR).

In some embodiments, at least two camera modules (e.g., 1300a, and 1300b) of the plurality of camera modules 1300a, 1300b, and 1300c may have different fields of view. For example, optical lenses of at least two camera modules (e.g., 1300a and 1300b) of the plurality of camera modules 1300a, 1300b, and 1300c may be different from each other, but are not limited thereto.

In addition, in some embodiments, the fields of view of the plurality of camera modules 1300a, 1300b, and 1300c may be different from each other. In this case, the optical lenses included in the plurality of camera modules 1300a, 1300b, and 1300c may also be different from each other, but are not limited thereto.

In some embodiments, the plurality of camera modules 1300a, 1300b, and 1300c may be arranged physically separate from each other. That is, rather than dividing the sensing area of one image sensor 1342 into the plurality of camera modules 1300a, 1300b, and 1300c, the image sensor 1342 may be arranged independently inside each of the plurality of camera modules 1300a, 1300b, and 1300c.

Referring again to FIG. 16, the application processor 1400 may include an image processing device 1410, a memory controller 1420, and internal memory 1430. The application processor 1400 may be implemented separately from the plurality of camera modules 1300a, 1300b, and 1300c. For example, the application processor 1400 and the plurality of camera modules 1300a, 1300b, and 1300c may be implemented separately from each other as separate semiconductor chips.

The image processing device 1410 may include a plurality of image processors 1411, 1412, and 1413, and a camera module controller 1414.

The image data generated from each of the camera modules 1300a, 1300b, and 1300c may be provided to the image processing device 1410 through image signal lines ISLa, ISLb, and ISLc, respectively, which are separated from each other. The image data may be transmitted using, for example, a camera serial interface (CSI) based on the MIPI. However, embodiments are not limited thereto.

The image data transmitted to the image processing device 1410 may be stored in the external memory 1600 before being transmitted to the image processors 1411 and 1412. The image data stored in the external memory 1600 may be provided to the image processor 1411 and/or the image processor 1412. The image processor 1411 may correct the received image data to generate a moving image. The image processor 1412 may correct the received image data to generate a still image. As an example, the image processors 1411 and 1412 may perform preprocessing operations, such as color correction, gamma correction, and the like, on the image data.

The image processor 1411 may include sub-processors. In an example case in which the number of sub-processors is equal to the number of camera modules 1300a, 1300b, 1300c, each of the sub-processors may process image data provided from one camera module. In an example case in which the number of sub-processors is less than the number of camera modules 1300a, 1300b, 1300c, at least one of the sub-processors may process the image data provided from the plurality of camera modules using a timing sharing process. The image data processed by the image processor 1411 and/or the image processor 1412 may be stored in the external memory 1600 before being transmitted to the image processor 1413. The image data stored in the external memory 1600 may be transmitted to the image processor 1412. The image processor 1412 may perform post-processing operations, such as noise correction and sharp correction, on the image data.

The image data processed by the image processor 1413 may be provided to the image generator 1700. The image generator 1700 may generate a final image by using the image data provided from the image processor 1413 according to image generating information or a mode signal.

Specifically, the image generator 1700 may merge, according to the image generating information or the mode signal, at least some of the image data generated from the camera modules 1300a, 1300b, and 1300c having different fields of view to generate an output image. In addition, the image generator 1700 may select any one of the image data generated from the camera modules 1300a, 1300b, and 1300c having different fields of view, according to the image generating information or the mode signal to generate an output image.

In some embodiments, the image generating information may include a zoom signal or a zoom factor. In addition, in some embodiments, the mode signal may include, for example, a signal based on a mode selected from a user.

In an example case in which the image generating information includes a zoom signal (or a zoom factor) and each of the camera modules 1300a, 1300b, and 1300c has a different field of view, the image generator 1700 may perform different operations according to the type of the zoom signal. In an example case in which the zoom signal includes a first signal, the image data output from the camera module 1300a and the image data output from the camera module 1300c may be merged, and then an output image may be generated by using the merged image signal and the image data output from the camera module 1300b that is not used for merging the image data. In an example case in which the zoom signal includes a second signal different from the first signal, the image generator 1700 may select any one of the image data output from the camera modules 1300a, 1300b, and 1300c to generate an output image without merging the image data. However, embodiments are not limited thereto. The method for processing image data may be modified and implemented as needed.

The camera module controller 1414 may provide control signals to the camera modules 1300a, 1300b, and 1300c. The control signals generated from the camera module controller 1414 may be provided to the corresponding camera modules 1300a, 1300b, and 1300c through the control signal lines CSLa, CSLb, and CSLc that are separated from each other.

In some embodiments, the control signals provided from the camera module controller 1414 to the plurality of camera modules 1300a, 1300b, and 1300c may include mode information according to the mode signal. Based on the mode information, the plurality of camera modules 1300a, 1300b, and 1300c may operate in a first operation mode and a second operation mode with respect to sensing speed.

In the first operation mode, the plurality of camera modules 1300a, 1300b, and 1300c may generate an image signal at a first speed (e.g., generate an image signal at a first frame rate), encode the image signal at a second speed higher than the first speed (e.g., encode the image signal at a second frame rate greater than the first frame rate), and transmit the encoded image signal to the application processor 1400. The second speed may be 30 times or less than the first speed.

The application processor 1400 may store the received image signal, that is, the encoded image signal, in the internal memory 1430 provided therein or the storage 1600 outside the application processor 1400, and then read and decode the encoded image signal from the internal memory 1430 or the storage 1600 and display the image data generated based on the decoded image signal. For example, the image processors 1411 and 1412 of the image processing device 1410 may perform decoding and may also perform image processing on the decoded image signal.

In the second operation mode, the plurality of camera modules 1300a, 1300b, and 1300c may generate an image signal at a third speed less than the first speed (e.g., generate an image signal at a third frame rate less than the first frame rate) and may transmit the image signal to the application processor 1400. The image signal provided to the application processor 1400 may include an unencoded signal. The application processor 1400 may perform image processing on the received image signal or store the image signal in the internal memory 1430 or the storage 1600.

The PMIC 1500 may supply power, e.g., a power supply voltage, to each of the plurality of camera modules 1300a, 1300b, and 1300c. For example, under the control by the application processor 1400, the PMIC 1500 may supply a first power to the camera module 1300a through a power signal line PSLa, supply a second power to the camera module 1300b through a power signal line PSLb, and supply a third power to the camera module 1300c through a power signal line PSLc.

The PMIC 1500 may generate power corresponding to each of the plurality of camera modules 1300a, 1300b, and 1300c, and adjust the level of the power, based on (or in response to) a power control signal PCON from the application processor 1400. The power control signal PCON may include a power adjustment signal for each operation mode of the plurality of camera modules 1300a, 1300b, and 1300c. For example, the operation mode may include a low power mode, where the power control signal PCON may include information about a camera module operating in the low power mode and a set power level. The level of power provided to each of the plurality of camera modules 1300a, 1300b, and 1300c may be the same as or different. In addition, the level of power may be dynamically changed.

According to the above-mentioned image sensor, aliasing due to down sampling during image processing may be reduced.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An image sensor, comprising:
a sensor board comprising a plurality of unit pixel groups, each of the plurality of unit pixel groups comprising a plurality of pixels configured to sense light and arranged two-dimensionally in a first direction and a second direction; and
an optical element provided on the sensor board configured to transmit incident light into each of the plurality of pixels, the optical element comprising a plurality of areas respectively facing the plurality of unit pixel groups,
wherein each of the plurality of unit pixel groups comprises a red pixel configured to sense light of a first wavelength band, a green pixel configured to sense light of a second wavelength band, and a blue pixel configured to sense light of a third wavelength band,
wherein the plurality of pixels in each of the plurality of unit pixel groups are arranged to have displacement vectors in a direction from a center of a respective unit pixel group, among the plurality of unit pixel groups, to a center of an arrangement of the plurality of pixels in the respective unit pixel group,
wherein a magnitude of each of a plurality of displacement vectors is equal to or greater than 0,
wherein the plurality of displacement vectors have an irregular distribution in a range of less than or equal to a maximum displacement, and
wherein the maximum displacement is less than a distance (s) between centers of adjacent pixels in the first direction.

2. The image sensor of claim 1, wherein the maximum displacement is s/√2.

3. The image sensor of claim 1, wherein, a component dx of the displacement vector in the first direction is equal to or greater than -s/2 and equal to or less than s/2.

4. The image sensor of claim 3, wherein the component dx is defined in each of the plurality of unit pixel groups and the plurality of dx has a Gaussian distribution in a range from -s/2 to s/2.

5. The image sensor of claim 1, wherein, a component dy of the displacement vector in the second direction is equal to or greater than -s/2 and equal to or less than s/2.

6. The image sensor of claim 5, wherein the component dy is defined in each of the plurality of unit pixel groups and has a Gaussian distribution in the range of -s/2 or more and s/2 or less.

7. The image sensor of claim 1, wherein a component dy of the displacement vector in the second direction is defined in each of the plurality of unit pixel groups and the plurality of the component dy has a Gaussian distribution in a range from -s/2 to s/2.

8. The image sensor of claim 1, wherein the plurality of unit pixel groups are grouped into a plurality of groups that are repeatedly arranged, a number of unit pixel groups, among the plurality of unit pixel groups, in each of the plurality of groups is same, and distributions of the displacement vectors within the plurality of groups are same.

9. The image sensor of claim 1, wherein the plurality of unit pixel groups are grouped into a plurality of groups that are repeatedly arranged, and distributions of the displacement vectors are different from each other in two or more of the plurality of groups.

10. The image sensor of claim 1, wherein the optical element comprises a nano-optical lens array comprising a plurality of nanostructures,
the nano-optical lens array comprises a plurality of unit structures respectively facing the plurality of unit pixel groups, and
each of the plurality of unit structures comprises a red pixel corresponding area, a green pixel corresponding area, and a blue pixel corresponding area respectively corresponding to the red pixel, the green pixel, and the blue pixel.

11. The image sensor of claim 10, wherein the plurality of unit structures are configured so that light is color-separated and focused within each of the plurality of unit structures independently.

12. The image sensor of claim 10, further comprising an optical diffuser provided on the nano-optical lens array.

13. The image sensor of claim 10, further comprising a color filter array arranged between the nano-optical lens array and the sensor board.

14. The image sensor of claim 1, wherein the red pixel comprises a red photodiode configured to selectively absorb light in a red wavelength band, the red pixel having a first width in a cross-section thereof perpendicular to a third direction,
the green pixel comprises a green photodiode configured to selectively absorb light in a green wavelength band, the green pixel having a second width in a cross-section thereof perpendicular to the third direction,
the blue pixel comprises a blue photodiode configured to selectively absorb light in a blue wavelength band, the blue pixel having a third width in a cross-section thereof perpendicular to the third direction, and
two of the first, second, and third widths are different from each other.

15. The image sensor of claim 14, wherein the optical element comprises a microlens array comprising a plurality of microlenses respectively facing the plurality of unit pixel groups.

16. The image sensor of claim 14, wherein one unit pixel group comprises one red photodiode, two green photodiodes, and one blue photodiode, and
wherein the two green photodiodes are located diagonally.

17. The image sensor of claim 14, wherein one unit pixel group comprises one red photodiode, two blue photodiodes, and one green photodiode, and
wherein the two blue photodiodes are located diagonally.

18. An electronic device, comprising:
a lens assembly that forms an optical image of an object;
an image sensor configured to convert the optical image formed by the lens assembly into an electrical signal; and
a processor configured to process signals generated from the image sensor,
wherein the image sensor comprises:
a sensor board comprising a plurality of unit pixel groups, each of the plurality of unit pixel groups comprising a plurality of pixels configured to sense light and arranged two-dimensionally in a first direction and a second direction; and
an optical element provided on the sensor board configured to transmit incident light into each of the plurality of pixels, the optical element comprising a plurality of areas respectively facing the plurality of unit pixel groups,
wherein each of the plurality of unit pixel groups comprises a red pixel configured to sense light of a first wavelength band, a green pixel configured to sense light of a second wavelength band, and a blue pixel configured to sense light of a third wavelength band,
wherein the plurality of pixels in each of the plurality of unit pixel groups are arranged to have displacement vectors in a direction from a center of a respective unit pixel group, among the plurality of unit pixel groups, to a center of an arrangement of the plurality of pixels in the respective unit pixel group,
wherein a size of each of a plurality of displacement vectors is equal to or greater than 0,
wherein the plurality of displacement vectors have an irregular distribution in a range of less than or equal to a maximum displacement, and
wherein the maximum displacement is less than a distance (s) between centers of adjacent pixels in the first direction.

19. The electronic device of claim 18, wherein the optical element comprises a nano-optical lens array comprising a plurality of nanostructures,
the nano-optical lens array comprises a plurality of unit structures respectively facing the plurality of unit pixel groups, and
each of the plurality of unit structures comprises a red pixel corresponding area corresponding to the red pixel, a green pixel corresponding area corresponding to the green pixel, and a blue pixel corresponding area respectively corresponding to the blue pixel.

20. The electronic device of claim 18, wherein the red pixel comprises a red photodiode configured to selectively absorb light in a red wavelength band, the red pixel having a first width in a cross-section thereof perpendicular to a third direction,
the green pixel comprises a green photodiode configured to selectively absorb light in a green wavelength band, the green pixel having a second width in a cross-section thereof perpendicular to the third direction,
the blue pixel comprises a blue photodiode configured to selectively absorb light in a blue wavelength band, the blue pixel having a third width in a cross-section thereof perpendicular to the third direction, and
two of the first, second, and third widths are different from each other.
